(19) United States
(12) Patent Application Publication
(10) Pub. No.: US 2007/0127426 A1
(43) Pub. Date: Jun. 7, 2007

(54) Development environment

(76) Inventors: Andrew Paul Watters, Auckland (NZ); Grant Christopher Harwood, Auckland (NZ)

Correspondence Address: DANN, DORFMAN, HERRELL & SKILLMAN, 1601 MARKET STREET, SUITE 2400, PHILADELPHIA, PA, 19103-2307, US

(21) Appl. No.: 11/586,942

(22) Filed: Oct. 26, 2006

Related U.S. Application Data
(60) Provisional application No. 60/730,531, filed on Oct. 26, 2005.

(51) Int. Cl. H04Q 7/24

(52) U.S. Cl. 370/338; 370/465

(57) ABSTRACT

The present invention may be said to consist in a method, system (1) and/or of configuring one or more mobile devices (4) to provide one or more user interfaces to at least one database on a remote computer system. An index of one or more shadow fields (e.g. 32, 35), each shadow field being associated with one or more of data fields in the at least one database can be defined. Input can be received defining a user interface (e.g. 64) to the at least one database for deployment on a mobile device. Configuration data can be generated specifying the user interface, the configuration data comprising data specifying one or more of the shadow data fields associated with the user interface. The configuration data is adapted to configure a mobile device (4) as a user interface to the at least one database.

### REFERENCE TO PRIOR APPLICATION

This application claims the benefit of U.S. Provisional Application No. 60/730,531, filed Oct. 26, 2005.

### FIELD OF THE INVENTION

The present invention relates to a system, software and/or method for enabling user configuration to integrate mobile devices with an enterprise computer system

### BACKGROUND OF THE INVENTION

Various mobile computing devices are available on the market that are connectable to telecommunications networks via various wireless protocols. Such devices include personal digital assistants (PDAs), mobile telephones with organiser functionality and the like. Many organisations wish to have their contractors and employees in the field use such devices in order to provide them with information relating to jobs that must be carried out and/or products that must be supplied to customers. The devices also enable the contractors/employees to record information relating particular jobs carried out, or products supplied.

To further improve on the flexibility and utility of such devices, it is desirable for the devices to be in communication with an enterprise computer system run by the enterprise, and generally located at the enterprise's offices. The computer system might include, for example, a database containing client, job and other useful information along with terminals and appropriate software for accessing the database. The software may also provide scheduling functionality so that an operator in the enterprise offices can schedule particular jobs and organise workload between various employees/contractors accordingly. The information between the mobile devices and the computer system at the enterprise can be synchronised, which enables the users of the mobile devices to receive up-to-date scheduling and job information, while the database can be periodically updated with the information entered into mobile devices by individual employees/contractors. Typically mobile devices are devices such as mobile phones, PDAs, handheld computers and the like that have transceiving functionality either over a mobile telephone network or some other suitable network.

As an example, the enterprise might provide trade services, such as plumbing. The enterprise computer system might include information on customers along with schedules of plumbing jobs that certain customers have requested be done. Information on the customers and jobs to be done can be deployed to the individual mobile device for each contractor/employee, so that the respective contractor/employee can view what jobs need carrying out, and can review the necessary customer information to carry out the job. Other information pertaining to the job can be provided via the mobile device, and also entered into the device by the contractor/employee. A specially designed graphical user interface (GUI) enables the user of the mobile device to view the information, and enter information, usually by way of a menu system. Periodically, as new information is entered into the device by the user on particular customers, this information is transferred back to the computer system, and the associated fields in the computer system are updated with the new information. Likewise, as new information is entered in data fields in the computer system, this information transferred to the mobile device, and the associated fields in the mobile device are updated with the new information. This data synchronisation takes place over a suitable communications channel using suitable protocols. Mobile devices can be used in a similar manner where the enterprise for whom the contractor/employees work provides products.

The difficulty, however, with such systems is there is no currently available system or other tool for enabling an enterprise to re-design and re-deploy different functionality that can be executed on the mobile devices and enable synchronisation to take place between the mobile devices and the enterprise computer system database. Often, the requirements for the scheduling, information transferral to the mobile devices and information entered into the mobile devices needs to change as the type of work or needs of the customers and/or enterprise changes. Any such changes require amendments to the mobile device GUI and functionality and the communication protocols between the mobile device and the enterprise database to allow data transfer between the two in relation to the new functionality.

At present, each mobile device vendor has proprietary development and communications protocols, and the enterprises themselves employ a wide range of operating systems, software and database structures. To alter the mobile device functionality and GUI and to allow data synchronisation for this altered functionality requires highly skilled labour to redevelop the system each time an amendment is required. This involves updating or amending the mobile device client software and also the enterprise computer system to enable transfer to take place for the new types of information transfer and functionality that are required. Therefore, there is a large overhead required and associated expense when a change is desired.

Therefore, it would be desirable to have a system, software and/or method in which a system operator could relatively easily develop new information retrieval, display and/or capture functionality for mobile devices along with a new GUI, all of which could be configured to integrate with the enterprise computer system to enable transfer of information over a communications channel to effect data synchronisation.

### SUMMARY OF THE INVENTION

It is an object of the invention to provide a system, computer program and/or method to assist in enabling a user to configure one or more mobile devices and/or associated computer systems to enable data transfer between the two, or at least to provide the public with a useful choice.

In one aspect the present invention may be said to consist in a method of configuring one or more mobile devices to provide one or more user interfaces to at least one database on a remote computer system, the method comprising the steps of: defining an index of one or more shadow data fields, each shadow data field being associated with one or more data fields in the at least one database, and receiving input defining a user interface to the at least one database for deployment on a mobile device, and generating configuration data specifying the user interface, the configuration data comprising data specifying one or more of the shadow data fields associated with the user interface, wherein the configuration data is adapted to configure a mobile device as a user interface to the at least one database by: configuring the mobile device to display, store and/or receive data entries in relation to the shadow data fields specified by the configuration data, and configuring the mobile device for data synchronisation of data entries in relation to the specified shadow data fields with data entries in the one or more associated data fields in the database.

Preferably the configuration data is adapted to be received and utilised by a mobile device to configure itself to provide the user interface.

Preferably the method further comprises the step of transferring the configuration data to one or more mobile devices during a communication session.

Preferably the configuration data is transferred over a non-persistent communications channel.

Preferably the configuration data is transferred periodically during a communication session.

Preferably the step of receiving input defining a user interface to the at least one database comprises receiving input specifying one or more display elements for display on the mobile device, and wherein the generated configuration data further comprises data specifying the display elements.

Preferably each display element relates to one or more shadow data fields.

Preferably the step of receiving input defining a user interface to the at least one database comprises receiving input specifying, for at least one display element, one or more of the shadow data fields related to that display element.

Preferably the display elements comprise one or more of: menu options, icons, requests for information, data input fields.

Preferably the configuration data is adapted to be received and utilised by a mobile device to configure itself to provide the user interface, the user interface comprising a graphical display of the menu elements.

Preferably the configuration data is adapted to be received and utilised by a mobile device to configure itself to provide the user interface that receives data in relation to one or more of the display elements and stores the received data in one or more of the shadow data fields specified for a respective display element for which data is received.

Preferably the step of receiving input defining a user interface to the at least one database comprises receiving input defining tasks and/or questions for display and/or storage on a mobile device, wherein the tasks and/or questions are associated with one or more of the shadow data fields.

Preferably the configuration data further comprises data specifying one or more of the tasks and/or questions for display and/or storage on the mobile device.

Preferably the tasks and/or questions are associated with display elements and/or shadow data fields related to display elements.

Preferably the configuration data is adapted to be received and utilised by a mobile device to configure itself to provide the user interface, the user interface comprising a graphical display of the tasks and/or questions.

Preferably prior to the step of transferring the configuration data to one or more mobile devices during a communication session, the method comprises the step of storing the configuration data in an intermediary store.

Preferably the method comprises the step of transferring the configuration data to one or more mobile devices during a communication session comprises transferring the configuration data from the intermediary store to a data store in each respective mobile device.

Preferably the method comprises the step of receiving data from one or mobile devices and storing the data in the intermediary store.

Preferably the method comprises the step of updating the at least one database with data in the intermediary store received from one or more mobile devices.

Preferably the method comprises the step of synchronising data in the data fields of the at least one database with data stored in relation to the shadow data fields specified by the configuration data.

Preferably the method comprises the step of transferring data from one or more data fields of the at least one database to one or more mobile devices for synchronising the specified shadow data fields associated with the user interface with associated data fields of the at least one database.

Preferably the method comprises transferring the configuration data to a plurality of mobile devices.

Preferably the step of receiving input defining a user interface to the at least one database for deployment on a mobile device comprises: receiving user input specifying the mobile device type of a desired vendor, emulating a graphical user interface of the mobile device, and receiving input selecting display elements with one or more associated shadow data fields.

Preferably the step of receiving input defining a user interface to the at least one database for deployment on a mobile device further comprises: receiving user input specifying the at least one database, and receiving user input specifying one or more shadow data fields.

Preferably the method comprises the steps of receiving the configuration data at a mobile device and configuring the mobile device as a user interface to the at least one database using the configuration data.

Preferably the method comprises the step of receiving further configuration data at the mobile device and re-configuring the mobile device as a re-configured user interface to the at least one database using the configuration data.

Preferably the method comprises the step of synchronising data in the specified shadow data fields with data in the data fields of the at least one database.

In another aspect the present invention may be said to consist in a system adapted to facilitate configuration of one or more mobile devices to provide one or more user interfaces to at least one database on a remote computer system, the system comprising: a computer system comprising, or adapted to communicate with, at least one database that comprises a data structure with one or more data fields, each data field for storing one or more data entries, the computer system comprising at least one computer programmed to: define an index of one or more shadow data fields, each shadow data field being associated with one or more data fields in the at least one database, and receive input defining a user interface to the at least one database for deployment to a mobile device, and generate configuration data specifying the user interface, the configuration data comprising data specifying one or more of the shadow data fields associated with the user interface, wherein the configuration data is adapted to configure a mobile device as a user interface to the at least one database by: configuring the mobile device to display, store and/or receive data entries in relation to the shadow data fields specified by the configuration data, and configuring the mobile device for data synchronisation of data entries in the specified shadow data fields with data entries in the one or more associated data fields in the database.

Preferably the configuration data is adapted to be received and utilised by a mobile device to configure itself to provide a user interface.

Preferably the system further comprises a definition file coupled to or integrated with the computer for storing the configuration data.

Preferably the system comprises a first transmitter and the computer is further programmed to transfer the configuration data to one or more mobile devices during a communication session via the first transmitter.

Preferably the configuration data is transferred over a non-persistent communications channel.

Preferably the configuration data is transferred periodically during a communication session.

Preferably to receive input defining a user interface to the at least one database the computer is programmed to receive input specifying one or more display elements for display on the mobile device, and wherein to generate configuration data specifying the user interface the computer is programmed to generate data specifying the display elements.

Preferably each display element relates to one or more shadow data fields.

Preferably to receive input defining a user interface to the at least one database the computer is programmed to receive input specifying, for at least one display element, one or more of the shadow data fields related to that display element, and wherein to generate configuration data specifying the user interface the computer is programmed to generate data specifying, for the at least display element, the one or more shadow data fields related to the at least one display element.

Preferably the display elements comprise one or more of: menu options, icons, requests for information, data input fields.

Preferably the configuration data is adapted to be received and utilised by a mobile device to configure itself to provide the user interface, the user interface comprising a graphical display of the menu elements.

Preferably the configuration data is adapted to be received and utilised by a mobile device to configure itself to provide the user interface that receives data in relation to one or more of the display elements and stores received data in one or more of the shadow fields specified for a respective display element for which data is received.

Preferably to receive input defining a user interface to the at least one database the computer is programmed to receive input defining tasks and/or questions for display and/or storage on a mobile device, wherein the tasks and/or questions are associated with one or more of the shadow data fields.

Preferably the configuration data further comprises data specifying one or more of the tasks and/or questions for display and/or storage on the mobile device.

Preferably the tasks and/or questions are associated with display elements and/or shadow data fields related to display elements.

Preferably the configuration data is adapted to be received and utilised by a mobile device to configure itself to provide the user interface, the user interface comprising a graphical display of the tasks and/or questions.

Preferably the system comprises an intermediary store coupled to or integrated with the computer wherein prior to transferring the configuration data to one or more mobile devices during a communication session, the computer is programmed to store the configuration data in the intermediary store.

Preferably transferring the configuration data to one or more mobile devices during a communication session comprises transferring the configuration data from the intermediary store to a data store in each respective mobile device using the first transmitter.

Preferably the system comprises a first receiver, wherein the system is adapted to receive data from one or mobile devices via the first receiver and store it in the intermediary store, the data comprising data in the specified shadow data fields.

Preferably the system is adapted to update the data fields of the at least one database that are associated with the specified shadow data fields, the data fields being updated with data from the intermediary store received from one or more mobile devices.

Preferably the computer is further programmed to transfer data from one or more data fields of the at least one database to one or more mobile devices via the first transmitter for synchronising the specified shadow data fields associated with the user interface with associated data fields of the at least one database.

Preferably to receive input defining a user interface to the at least one database for deployment to a mobile device, the computer is programmed to: receive user input specifying the mobile device type of a desired vendor, emulate a graphical user interface of the mobile device, and receive input selecting display elements with one or more associated shadow data fields.

Preferably to receive input defining a user interface to the at least one database for deployment to a mobile device, the computer is further programmed to: receive user input specifying the at least one database, and receive user input specifying one or more shadow data fields.

Preferably the system comprises at least one mobile device, the device comprising a second receiver adapted to receive configuration data transmitted via the first transmitter, wherein the mobile device is adapted to configure itself as a user interface to the at least one database using the received configuration data.

Preferably the mobile device is adapted to receive further configuration data transmitted via the first transmitter and re-configure itself as a re-configured user interface to the at least one database using the additional configuration data.

Preferably the mobile device further comprises a second transmitter, wherein the device is adapted to transmit data to the intermediary store via the first receiver, the data being for updating the data fields of the at least one database that are associated with the specified shadow data fields.

Preferably the mobile device is adapted to periodically communicate with the intermediary store to receive configuration data, and periodically re-configure itself as a user interface to the at least one database using the configuration data.

In another aspect the present invention may be said to consist in a mobile device comprising a transceiver and configuration software, the mobile device adapted to receive the configuration data, and adapted to configure itself with the configuration software using the configuration data to provide a user interface to the at least one database.

In another aspect the present invention may be said to consist in a method for facilitating configuration of a mobile device and integration of the mobile device with a remote computer system comprising at least one database, to provide for data synchronisation between the mobile device and the remote computer system, the method comprising: configuring a mobile device functionality and/or user interface, comprising selecting menu elements for display, methods for the elements and one or more shadow data fields related to the elements and associated with data fields in the database, using software that configures a system to facilitate data synchronisation between the mobile device and database.

In another aspect the present invention may be said to consist in a computer program for operating a computer connected to at least one database to facilitate configuration of a mobile device to provide a user interface to the at least one database on a remote computer system, the computer program comprising: a index module adapted to enable the definition of an index of one or more shadow data fields for use in configuring the mobile device, each shadow data field being associated with one or more data fields in the at least one database, each data field in the at least one database containing one or more data entries, and a user configuration module adapted to enable configuration of the functionality of the mobile device, the user configuration module enabling a user to select one or more of the shadow data fields, wherein the user configuration module generates configuration data for configuration of a mobile device to display, store and/or receive data entries in relation to the selected shadow fields and for data synchronisation of: data entries in the selected shadow fields displayed, stored or received on the mobile device, and data entries in the one or more associated data fields in the database.

Preferably the configuration data is adapted to be received by the mobile device during a communication session, and adapted to be utilised by the mobile device to configure itself as defined by the configuration data.

Preferably the configuration data further defines tasks and/or questions for display and/or storage on the mobile device, and wherein the configuration data is adapted to be received and utilised by a mobile device to configure itself to receive, display and/or store tasks and/or questions defined by the configuration data receive data entries in respect of those tasks and/or questions.

Preferably the tasks and/or questions are associated with one or more of the shadow data fields.

Preferably the configuration data is adapted to be stored in a definition file that is in communication with a data store in the mobile device.

Preferably the user configuration module is further adapted to receive user input specifying display elements for association with one or more of the selected shadow data fields, the user configuration module adapted to generate configuration data defining the display elements and the respective associations of those display elements with one or more of the selected shadow data fields, the configuration data being adapted to be received and utilised by a mobile device to configure itself to display the specified display elements.

Preferably the display comprises one or more of menu options, icons, requests for information, data input fields.

Preferably the configuration data is adapted to be received and utilised by a mobile device to configure itself to receive data in relation to one or more of the display elements and store received data in one or more shadow fields associated with a respective display element for which data is received.

Preferably the computer program facilitates configuration of a plurality of mobile devices.

Preferably the computer program facilitates configuration of a plurality of different mobile device types supplied by different vendors.

Preferably the user configuration module is adapted to: receive user input specifying the mobile device type of the desired vendor, emulate a graphical user interface of the mobile device, and display user specified display elements and/or the data entries for the selected shadow fields associated with those specified display elements.

Preferably the user configuration module simulates data synchronisation between data entries display, stored and/or received in respect of the selected shadow fields and data entries in the associated data fields in the database.

Preferably the configuration data is adapted to be stored in an intermediary store prior to data transfer to a mobile device.

Preferably the computer program comprises a run-time scheduling module for editing display elements, requests, tasks and information, the run-time scheduling module adapted to receive user input specifying changes to display elements, requests, task and information and generates update configuration data defining the changes, the update configuration data being adapted to received and utilised by a mobile device to configure itself as defined by the configuration data.

In another aspect the present invention may be said to consist in a method of configuring one or more mobile devices to provide one or more user interfaces to at least one database on a remote computer system, the method comprising the steps of: defining and storing an index of one or more shadow data fields, each shadow data field being associated with one or more data fields in the at least one database, and receiving user input defining a user interface to the at least one database for deployment on a mobile device, the user input comprising input specifying menu elements that are related to one or more shadow data fields, and input specifying one or more of the shadow fields to be associated with the specified menu elements, and generating configuration data specifying the user interface, the configuration data comprising data specifying the specified menu elements and the one or more specified shadow data fields associated with the specified menu elements, transferring the configuration data to at least one mobile device for use in configuration of the device to provide one or more user interfaces to the at least one database, and configuring the mobile device using the configuration data, wherein the configuration data is adapted to configure a mobile device as a user interface to the at least one database by: configuring the mobile device to display, store and/or receive data entries in relation to the shadow data fields specified by the configuration data, and configuring the mobile device for data synchronisation of data entries in relation to the specified shadow data fields with data entries in the one or more associated data fields in the database.

In another aspect the present invention may be said to consist in a system adapted to facilitate configuration of one or more mobile devices to provide one or more user interfaces to at least one database on a remote computer system, the system comprising: an enterprise computer system, at least one database communicating with or forming part of the enterprise computer system, the at least one database comprising a data structure with one or more data fields, each data field for storing one or more data entries, a configuration computer system adapted to communicate with the at least one database, at least one system transceiver form communicating with at least one mobile device, and at least one mobile device with a transceiver for communicating with the configuration computer system via the system transceiver, wherein the computer system comprising at least one computer programmed to: define an index of one or more shadow data fields, each shadow data field being associated with one or more data fields in the at least one database, and receive input defining a user interface to the at least one database for deployment to a mobile device, and generate configuration data specifying the user interface, the configuration data comprising data specifying one or more of the shadow data fields associated with the user interface, wherein the system is adapted to transmit the configuration data to the mobile device via the transceiver, and wherein the configuration data is adapted to configure a mobile device as a user interface to the at least one database by: configuring the mobile device to display, store and/or receive data entries in relation to the shadow data fields specified by the configuration data, and configuring the mobile device for data synchronisation of data entries in the specified shadow data fields with data entries in the one or more associated data fields in the database.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

The term “comprising” as used in this specification means “consisting at least in part of”. Related terms such as “comprise” and “comprised” are to be interpreted in the same manner.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting

### BRIEF DESCRIPTION OF THE DRAWINGS

Preferred embodiments of the invention will be described with reference to the following drawings, of which:

FIG. 1 is a schematic diagram showing an overview of a system according to a preferred embodiment of invention, including a configuration interface,

FIG. 2 is a schematic diagram showing components of a preferred embodiment of the software that is implemented in a preferred embodiment of the system,

FIG. 3 is a block diagram showing a preferred embodiment of the system,

FIG. 4 shows a graphical user interface of the Mapped Data Field Index Generation module, including an example of typical selections,

FIG. 5 shows an example of a typical data structure in an enterprise database and the mapping of fields in that database into the Mapped Data Field Index,

FIG. 6 shows a graphical user interface of the User Configuration Module for configuring the mobile device and data transfer process,

FIG. 7 shows a graphical user interface of the Run-time Scheduling Module,

FIG. 8 shows a configured menu as it is displayed on the mobile device,

FIG. 9 shows a configured task list screen including scheduled tasks as it is displayed on the mobile device,

FIG. 10 shows a configured question sub-menu as it is displayed on the device,

FIG. 11 shows an information screen for display of general information on a mobile device,

FIG. 12 shows a typical data structures for the various configuration data files used in the system,

FIG. 13 shows a flow diagram of a method according a preferred embodiment of the invention, and

FIG. 14 shows a flow diagram of a method configuring a mobile device in accordance with another embodiment of the invention,

FIGS. 15a-15g show screen shots of the configuration module at various points of the configuration,

FIGS. 16a, 16b show user interface displayed on the mobile device in accordance with the configurations in FIGS. 15a-15h,

FIG. 17 shows a screen shot of a task configuration module, and

FIGS. 18a, 18b show the tasks displayed on a user interface of a mobile device.

### DETAILED DESCRIPTION OF THE PREFERRED EMBODIMENTS

Overview of System and Software

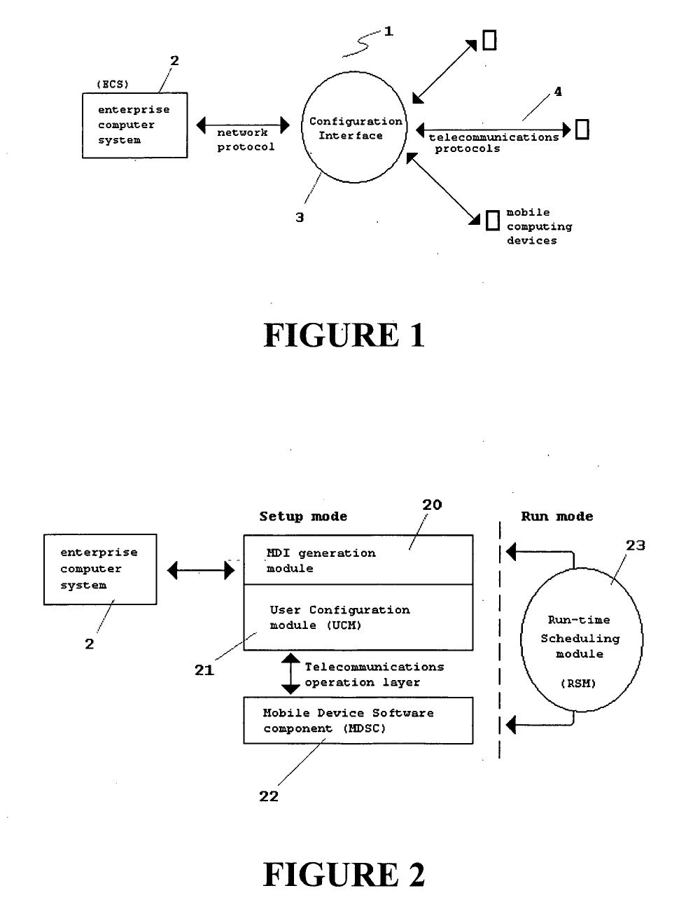

FIG. 1 shows in schematic form an overview of a system 1 in accordance with a preferred embodiment of the invention. The system 1 includes an enterprise computer system 2 (ECS), including one or more databases, integrated with a number of mobile devices 4 deployed in the field for assisting each contractor or employee of the enterprise with task scheduling, and in particular the planning, actioning and documenting of services carried out for clients on behalf of the enterprise and/or products supplied in accordance with the enterprise's business model. The system 1 facilitates task scheduling, and uses the mobile devices 4 to convey the scheduling information to the contractors/employees and capture scheduling information from the employees/contractors. It will be appreciated that the term task scheduling relates to more than just the tasks themselves, but also refers to the information associated with the scheduled tasks, both provided to and received by the contractors/employees carrying out the tasks and the functionality deployed to the mobile device to implement scheduling. The mobile devices 4 facilitate this function by providing a range of hierarchical menus in a graphical user interface (GUI), each with displayed menu elements that might relate to a request to input information, information associated with a data field in the enterprise computer system, or a link to a sub-menu. The data on the mobile device can be synchronised with data in the enterprise computer system such that the scheduling information on both is replicated. It will be appreciated that in this specification, any description relating to a mobile device can be extended to a range of such devices all of different types. Typically mobile devices are devices such as mobile phones, PDAs, handheld computers and the like that have transceiving functionality either over a mobile telephone network or some other suitable network.

For example, the enterprise might provide trade services, such as plumbing. The enterprise computer system 2 might include information on customers along with schedules of plumbing jobs that certain customers have requested be done. Information on the customers and jobs to be done can be deployed to the individual mobile device for each contractor/employee, so that the respective contractor/employee can view which jobs need carrying out, and can review the necessary customer information to carry out the job. Other information pertaining to the job can be provided via the respective mobile device 4, and also entered into the device by the contractor/employee. Information on each mobile device 4 and in the enterprise computer system 2 can be periodically synchronised through an update procedure.

In a preferred embodiment of the invention, a configuration interface 3 is provided which forms an intermediary component of the overall system 1. The configuration interface 3 comprises software running on a computer system that is in communication with the business computer system 2 and the mobile devices 4 operated by users in the field carrying out work under instruction of the enterprise. The configuration interface 3 facilitates the configuration of the mobile devices 4 to provide the required functionality and GUI to assist users in carrying out the work, enable access to required information from the enterprise computer system 2 to carry out the work, facilitates the deployment of the configuration to the mobile devices 4, and facilitates the configuration of the overall system 1 to enable data transfer between the mobile devices 4 and the enterprise computer system 2 to enable data synchronisation. In effect, once configured, each mobile device is provides a user interface to the one or more databases in the enterprise computer system 2. Here, the term “user interface” refers to more than just a graphical user interface, but all the associated functionality to allow a user at least partial access to information in the databases, and also exchange information therewith. The user interface also comprises configuration of protocols and the like that facilitate data transfer and synchronisation between data on the mobile device and data in the database. The system allows for dynamic updating of the mobile devices in accordance with the configurations made by a user through the configuration interface. Configuration data generated through the configuration process can be received and used by a mobile device to configure itself. It also allows for data exchange or synchronisation of data in relation to the configurations made. The mobile device configuration can be continually or periodically updated, in accordance with configuration data changes as part of the data synchronisation process.

More particularly, in overview, the configuration interface communicates with the enterprise computer system 2 and allows a system operator to interrogate the various databases it implements, and view the various data fields used in the data structures of those databases. The system operator can then utilise the configuration interface 3 to select various data fields and produce an index of shadow data fields each mapped to one or more data fields in the database. The shadow data fields chosen will contain data entries useful in carrying out task scheduling. For example, they may be data fields relating to customer names, addresses, order numbers and customer history. The software of the configuration interface 3 then enables the user to configure the system to enable access to these fields via the users mobile device and allow data synchronisation between the two. This facilitates the data scheduling process of the system 1.

There are several aspects to the configuration. The first is a configuration of a GUI and functionality of the mobile devices to provide a user interface, to display menu options, information, information requests and other display items or elements to enable task scheduling information to be conveyed to a user of the mobile device, and capture information from them. This configuration can be different for each different type of mobile device in the system. In doing so, the software configures the system to allow deployment of those configuration settings to the each mobile device, and also configures the system to allow data synchronisation with each newly configured mobile device. Therefore, the system 1 not only allows for configuration of new functionality for each mobile device, but also carries out the underlying configurations required to ensure the newly configured mobile devices are integrated into the system 1 overall, so that data transfer can take place. In a preferred embodiment, the configuration interface 3 is implemented as software that communicates with the enterprise computer system 2 and the various mobile devices 4. The configuration interface 3 could for example sit on a computer that is connected via a LAN or other computer network to ECS 2. The configuration interface 3 and ECS 2 could form part of the same overall system and be located centrally or remotely. The database or databases operated by the enterprise could physically form part of the ECS 2, or could be remotely located. FIG. 1 shows the logical arrangement of these components, but not necessarily the physical implementation. Many possible physical implementations could be envisaged by those skilled in the art. The system 1 also comprises a transceiver (or a separate transmitter and receiver) to allow for data transfer between the mobile devices and the ECS 2 and configuration interface 3.

It will be appreciated that the term enterprise relates to any commercial or non-commercial business, company organisation or the like that provides some type of service, product or other activity.

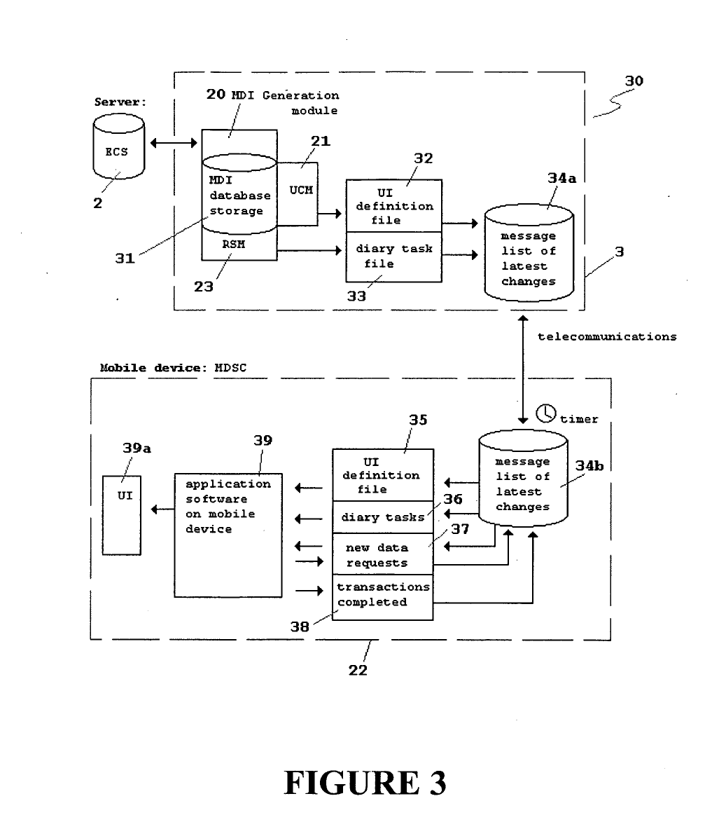

FIG. 2 indicates in schematic form an overview of the components 20-23 of the preferred embodiment of the configuration interface 3. A mapped data field index (MDI) generation module 20 is provided, which communicates with the enterprise computer system (ECS) 2. The MDI generation module 20 interrogates the databases of the ECS 2 and enables the system operator to view the various data fields implemented in the data structures of the various databases in the ECS 2. The data fields contain data entries representing stored information. The MDI generation module 20 enables the user to select the data fields they wish to utilise in the mobile device task scheduling functionality, and after selection, the MDI generation module produces an index of shadow data fields that replicate or are mapped to the associated fields in the various databases in the ECS 2 that have been selected by the user. The shadow data fields in the index may be given aliases by the user. The mapped data field index (MDI) 31 (seen in FIG. 3) replicates the information from the associated field in the ECS 2 selected by the system operator or user. That is, it is a database with a data structure defining the selected shadow fields, and comprises data entries in each shadow data field that replicate the data entries in the associated fields in the ECS 2. The data entries in each data field (or data source) is termed a “dataset”. While generally there will be one to one mapping between the shadow data fields and the data fields in the EBS 2 databases, this is not a requirement. The MDI produced by the MDI generation module 20 then provides the system operator with a repository of shadow data fields for use in configuring the mobile device task scheduling process for deployment to the mobile devices 4. This index or library is maintained by the system operator and may be updated at any time to add or remove references to reflect changes in data source requirements. A choice of data format protocol is provided, using contemporary descriptor standards for data storage technology such as ODBC (object database connectivity), MS Excel (®Microsoft), MS Outlook (®Microsoft), csv (comma separated value), xml (hypertext markup language). The software displays source data extraction views of all fields defined by the MDI generation module 20.

As shown in FIG. 2, the configuration interface 3 further includes a user configuration module (UCM) 21 that enables the user to design and emulate the desired functionality and GUI for each mobile device 4 of the system. In particular, the emulation software enables the user to design the mobile device GUI to display the required menu elements, information requests (questions) and other information, and where required, link the menu elements to the shadow data fields defined in the MDI 3. Configuration data is then generated to reflect the user configurations. During synchronisation the configuration data is passed to each mobile device. Each device then configures itself with the configuration data to provide a user interface to the database. This includes configuring a GUI and back end interfaces/protocols to facilitate data exchange between the mobile device and database. During synchronisation, change advice records (to be described later) relating to datasets from the ECS 2 database data fields associated with the shadow fields are transferred to each mobile device 4 for presentation to the respective users and information entered into each mobile device 4 in respect of shadow data fields therein is transferred back to the associated data fields in the ECS 2.

The UCM 21 enables functionality and GUIs to be emulated and configured for a range of different mobile device types from different vendors. The emulator enables design of a consistent user interface applicable to the technical constraints of the particular mobile device—for example, screen size and viewing capability, peripheral device availability such as barcode scanners, global positioning systems (GPS) and handwriting recognition capacity. The emulator depicts a visual representation of the particular mobile device, along with the user configuration of its GUI. The UCM 21 also enables the system operator to simulate their mobile device 4 configuration, prior to deployment of the configuration to the actual device. As mentioned above, the UCM 21 also generates configuration data in accordance with the mobile device user interface emulations developed by the system operator. This includes configuration data for deployment to the mobile devices 4 to enable configuration of those devices in accordance with the emulations, and configuration data that facilitates data transfer to synchronise data between shadow data fields implemented on the mobile devices 4 and the associated data fields on the ECS 2. The configuration data relates to display items chosen by a user using the UCM 21 and also comprises data relating to shadow data fields relating to those display items. The configuration data comprises the data required for a mobile device to configure itself as a database interface as specified by the user.

In addition to the configuration interface 3, preferably each mobile device 4 has a Mobile Device Software Component (MDSC) 22 installed. The MDSC replicates a user interface for each mobile device 4 exactly as configured by the UCM. This is effected by a software program installed onto the mobile device 4 which reactively generates its GUI from definition files 32 relayed from the UCM 21 in over the communications layer. The definition files 32 store configuration data as described previously. The configuration data in the definition files 32 also allows data exchange, or synchronisation of datasets between the shadow fields and associated database data fields defined by the configuration data. This application sits on each mobile device 4, and uses the configuration data generated by the configuration interface 3 to configure the mobile device such that it executes the functionality and GUI configured by the system operator, and to integrate the mobile device with the ECS 2. In particular, it configures the mobile device to display the GUI designed by the system operator, and it also facilitates the transfer of data to enable data synchronisation with the ECS 2. This results in the mobile device functioning as a user interface to the database. The MDSC 22 receives the configuration data over a telecommunications layer 24 to be described later on.

The MDI generation module 20 and UCM 21 implement the setup mode of the invention, to generate configuration data and simulate capability, as described above. Once the configuration process is complete, the configuration data is deployed to the mobile devices 4, and the invention enters a run-time mode. An advantage of the invention is that it also allows for re-configuration at run-time, without interrupting the operation mode. Preferably, a Run-time Scheduling Module (RSM) 23 is also included in the configuration interface that provides a run-time manual user interface to the ECS 2 and the mobile devices 4. This enables a user to provide, edit and re-arrange scheduling status data on the business computer system and the mobile devices 4.

### Detailed Description of System and Software According to a Preferred Embodiment of the Invention

FIG. 3 shows a schematic diagram of the architecture of a preferred embodiment of the system 1, including software executed on the system 1. The system 1 comprises a server-side subsystem 30 and a mobile device subsystem. The server-side subsystem 30 comprises the ECS 2 and the configuration interface 3 (shown in dotted lines), which is software executing on a computer system as described above. The mobile device subsystem comprises one or more mobile devices 4, all executing the MDSC 22 (shown in dotted lines). Only one mobile device is shown for clarity. Any suitable number of mobile devices can be implemented in the system each running the MDSC 22. An existing enterprise might implement the system by acquiring the required software for the configuration interface 3 and using this to configure existing (or new) mobile devices to create the overall system shown in FIGS. 1 to 3.

The ECS 2 includes one or more databases storing information relating to the enterprise's business. This may include information such as customer name, address, customer history, customer account information, order and job numbers and the like. This information is stored as individual data entries in respective data fields that are defined in the data structure of the database. The data entries for each data field form a dataset. For example, each of the customer, customer address, customer number and the like is an individual data field defined in the database, with individual data entries relating to respective records. Multiple data fields may form part of a table, each table forming part of a database. The ECS 2 is in communication with the configuration interface 3. The configuration interface comprises a computer system with a computer running software that includes the MDI generation module 20, a MDI 31, and the UCM 21. A MDSC 22 is on the mobile device 4. All of these modules function as described briefly in relation to FIG. 2 above and will be described in further detail below.

The MDI generation module 20 defines which datasets from the ECS 2 are to be replicated as a synchronised database in the MDI 31. Any industry standard database synchronisation protocol may be utilised for this function (e.g. Oracle PL/SQL or SQL triggers) or a batch or update process to refresh the data on a timer. The MDI 31 provides a database storage of replicated data from the ECS 2 as defined by the MDI generation module 20. The datasets in the shadow data fields in the MDI 31 are updated periodically to reflect changes in the datasets of the associated data fields in the enterprise-computer system. So the entire system is based on a fault-tolerant data redundancy communications backbone.

Acting from data within this MDI 31 database, the UCM 21 extracts for each individual participating mobile device 4 a temporary User Interface (UI) definition file 32. This file stores configuration data relating to the shadow fields (and the datasets contained in them) defined in the MDI 31 that have been selected by the system operator for deployment to a respective mobile device. It also contains all other configuration data to be used to configure a mobile device as a user interface. The UCM 21 is in communication with the UI definition file 32 that stores configuration data.

Likewise the RSM 23, in accordance with system operator selections, extracts a temporary file of current diary tasks defined for the individual participating mobile device 4 assigned. The RSM 23 is in communication with the diary task store 33 which stores configuration data defining diary tasks and other similar scheduling information that is generated by the system operator in the RSM 23. The UI definition file 32 and task store 33 implement XML data structures containing for each data segment to be transmitted, a standardised header descriptor to specify intended target location appended to variable content as selected, for storing the required configuration data.

The UI definition file 32 and task store 33 are in communication with a temporary update store 34a which is a temporary intermediary store reflecting any changes in the UI definition file 32 and task store 33 that have occurred since the last synchronisation process. This is also termed an intermediary store as it acts as an intermediary repository to allow for transfer of data to allow synchronisation between shadow fields in the mobile device and the database in the ECS 2. That is, they include changes relating to: i) datasets stored in data fields in the ECS 2 associated with the shadow data fields defined in the MDI 31 and selected for deployment to a respective mobile device 4, ii) changes in the shadow data field selections for deployment to a respective mobile device 4, and iii) changes in diary tasks effected by the system operator using the ECS 2. The temporary update store 34a also includes data representing changes in respect of diary tasks and datasets that have been specified on the respective mobile device and that have been transferred from the mobile device to the temporary store during a previous data update process for the purposes of altering the computer system data fields to reflect those changes.

The configuration interface 3 on the server-side subsystem according to the invention 1 is in communication with the MDSC 22 installed on each mobile device that forms part of the overall system 1. Preferably, the MDSC 22 on each respective mobile device 4 and the configuration interface 3 are in a non-persistent communication, whereby updates occur periodically. The MDSC 22 comprises a temporary intermediary update store 34b, similar to that in the UCM 21 which is a temporary store of data reflecting any changes in the UI definition file 32 and diary task file 33 of the UCM 21 that have occurred since the last synchronisation (update) process. The temporary update store 34b also comprises data representing changes in respect of diary tasks and datasets that have been specified on the respective mobile device 4 for transfer to the UCM 21 temporary store 34b during the next synchronisation procedure for the purposes of altering the ECS 2 data fields to reflect those changes.

The temporary update store 34b exchanges data with a UI definition file 35 and task store 36, and also new data request file 37 and a completed transaction file 38 all of which form part of the MDSC 22. The MDSC 22 also includes the application software 39 which exchanges data with these files to facilitate data transfer to achieve data synchronisation, and it also receives configuration data from them and uses this to configure the MDSC 22 functionality and the mobile device GUI 40 in accordance with configuration data produced by the UCM 21.

In summary, the system allows the definition of a user interface comprising menu elements and shadow data fields relating to data fields in the ECS 2. The shadow data fields are related to menu elements as selected by the user undertaking the configuration process. The MDI 31 is periodically updated such that the data sets in those shadow data fields reflect the data sets in the associated data fields of the ECS 2. These shadow data fields can be accessed through the UCM 21, and used by a system operator to define the functionality and GUI of each mobile device. Different shadow data fields might also be defined during updates. Once the configuration has taken place for a particular mobile device the UCM generates configuration data which is stored in the UI definition file 32 and diary task file 33 for deployment to the particular mobile device during the next synchronisation procedure. The configuration data specifies the user interface to be configured on a mobile device, including menu elements, shadow data fields and other data to affect configuration. The U1 definition file 32 and diary task file 33 also include data received from the mobile device 4 during the last data synchronisation procedure for updating the ECS 2 such that the data sets of the data fields therein reflect those of the associated shadow data fields in the mobile device 4. The temporary update store 34a stores configuration data from the UI definition file 32 and diary task file 33 for transfer to the mobile device 4 and also includes data received during the last data synchronisation process from the mobile device 4 for transfer to the UI definition file 32 and diary task file 33. The temporary update store 34a is in non-persistent communication with a respective temporary update store 34b in a MDSC 22 installed on the mobile device. The communication is via a transceiver (or transmitter and receiver) in the server-side subsystem 30 and the respective transceivers in the mobile devices. This could be over a mobile telephone network, or some other suitable network. The temporary data store 34b also contains configuration data received from the temporary update store 34a in the UCM 21 received during the last synchronisation process. It also contains data from its UI definition file 35 diary task file 36 new data request file 37 and completed transactions file 38 for transfer to the temporary update store 34a of the UCM 21 during the next update process. This data is used to synchronise the ECM 22 with the data on the mobile device. The MDSC 22 on the mobile device also includes the application software for utilising configuration data to configure the functionality of the mobile device and the user interface.

Data synchronisation enables data transfer such that the data entries in the specified shadow fields and the data entries in the associated data fields of the database are altered to mirror each other. Alternatively, data entries in the specified shadow fields are altered to match those data entries in the associated data fields of the database. Alternatively, data entries in the data fields in the database are altered to match the specified shadow fields with which they are associated. Alternatively, some other data transfer regime takes place between the specified shadow fields and the associated data fields in the database.

The configuration data is stored in a configuration data store, comprising the U1 definition file 33 and/or diary task file 33. The data store is in communication with a data store 34b in the mobile device. An application running on the mobile device has the ability to self-configure and re-configure its own user interface dynamically acting on message files in the configuration data store 32, 33 from each system to which the mobile device is addressed. Given this capability, it is possible that various user configuration modules hosted by various enterprises may each deploy a customised application to the same mobile device, which can select upon start up which host user configuration module session the user wishes to participate in at that time.

Each of the components of the system architecture 1 shown in FIG. 3 will now be described in detail.

Mapped Data Fields Index (MDI) and Mapped Data Fields Index (MDI) Generation Module

As described in the overview, the MDI generation module 20 enables a system operator or user to select the desired data fields defined in the database structure of the ECS 2 for use in the UCM 21 to configure mobile device 4 as a user interface, including task scheduling functionality and GUI. The selected fields are mapped and stored in the MDI 31.

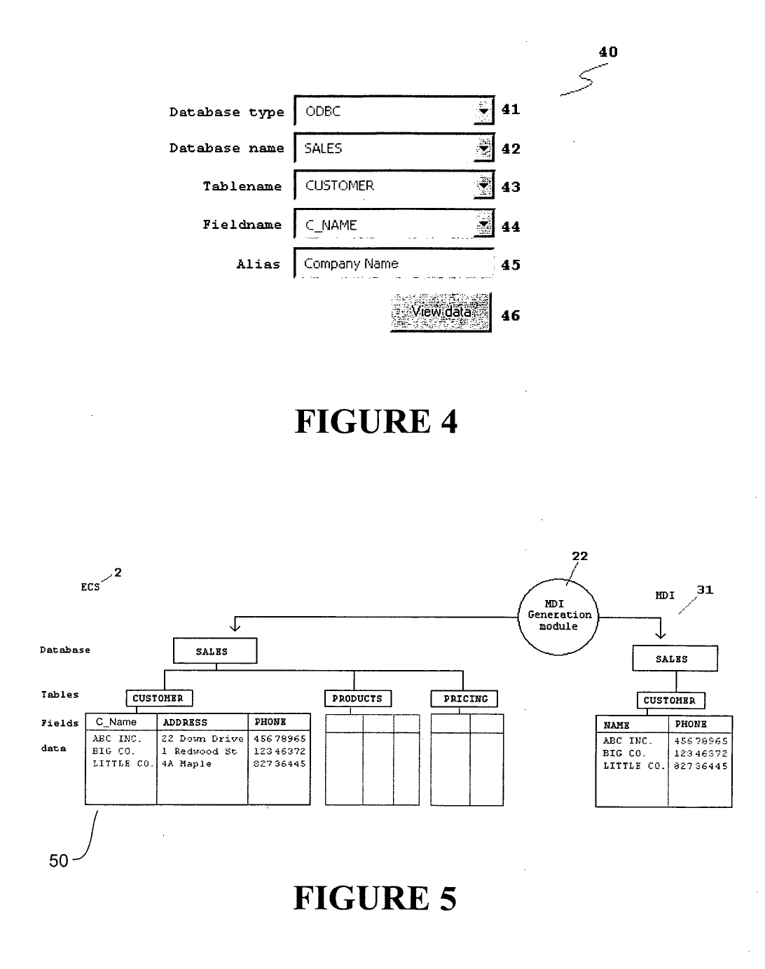

FIG. 4 shows in schematic form a generic GUI 40 for operating the MDI generation module 20, containing a number of fields with example selections as shown. FIG. 5 shows an example data structure 50 of a database in the ECS 2, and an example mapped index in the MDI 31, generated using the GUI 40. As can be seen, the example database structure comprises one database called “SALES”, (although in the general case there will be multiple databases) which includes tables called “CUSTOMER”, “PRODUCTS” and “PRICING”. The “CUSTOMER” table includes the data fields named “C₁₃ NAME”, “ADDRESS” and “PHONE” with the fields being populated with the data entries as shown. It will be appreciated that the “PRODUCTS” and “PRICING” tables will also have defined data fields and data entries, although these have been omitted for clarity. Further, there may be more than database, although again, only one is shown here for clarity.

In overview of the MDI generation process, the system operator uses the MDI generation module 20 to select from the available list of databases 42 (or inputs a valid connection string) and then selects from a list of tables 43 within that database, then selects from a list of field names 44 within that table, which datasets the user wishes to nominate for the MDI to maintain as an offline storage replication of the enterprise computer system data. The system operator may optionally define an ‘Alias’ (alternate descriptor) for each field, to make the MDI 31 dataset more readable.

Referring to FIG. 4, the interface 40 includes a selection box 41 providing pre-defined options of standard database connection types, which the user may choose. In this case an ODBC connection method is used to connect to the ECS 2 database. A range of other connection methods could be provided for selection. The interface 40 also includes a database name selection box 42 indicating which of the databases in the ECS 2 the MDI generation module 20 should connect to. In this example, the database named “SALES” is selected from a number of filename location descriptions for the databases in the ECS 2. A table name selection box 43 is provided to select a table name (e.g. “CUSTOMER”) from within the “SALES” database, and a field name selection box 44 is provided to select a field name (e.g. “C_NAME”) from within the “CUSTOMER” database table. An alias input field 45 is provided for optional input of an alias, namely an alternative reference title for the field name. This alias “NAME” is used in the MDI 31. An activation button 46 enables the user to view an extract of the data specified, for visual verification of a sample of the selected data contents. The user interface 40 can be used to select and alias a number of different field names, from a number of different table names, from a number of different databases in the ECS 2. For each selected field name, a corresponding shadow data field is created in a MDI 31, as shown in FIG. 5. In this case a mapped data structure of including the “C_NAME” and “PHONE” fields of the “CUSTOMER” table of the “SALES” database is shown. The “NAME” shadow data field and associated entries are shown as generated according to the example in FIG. 4. The “PHONE” shadow data field shown would be generated in a similar manner.

The purpose of the MDI generation module 20 and MDI 31 is to create an indirect link between the ECS 2 databases and the mobile device platform. It can be seen that this definition structure supports discrete mapping of any available data fields within a standard RDBMS (relational database management system). Passwords required by the ECS 2 for security access to these tables, will be prompted as required from this screen. This first part of the setup process preferably occurs in a secure, high-bandwidth network environment attached to the business computer system by TCP/IP, which is suited for the resource intensive task of mapping and synchronizing a replicated database potentially accumulated from various sources including multiple mobile devices.

In a possible implementation, a software program is developed using the Microsoft.NET development environment to display the user screens described following and carry out all technical functions automatically as required transparent to the user. This is facilitated by an ADODB connection from within the Microsoft.NET development environment which enumerates to the user of the MDI generation module 20, all available data sources registered on the host computer via standard ODBC connections on the attached TCP/IP network server(s). Having generated the MDI 31, the MDI generation module 20 then perpetually maintains a regular or persistent data synchronization via the internal (industry standard) ADODB connection method in both directions as required to maintain an offline replicated subset of the server data in a format suitable for use by UCM 21. In the preferred embodiment, this data would be stored in an industry-standard RDBMS such as MSAccess mirroring the structure of the source data tables selected from the ECS 2 databases, for example as shown in FIG. 5. Note however that the data storage format is not limited to a defined RDBMS structure but may alternatively be stored in an XML text format structured to suit the data contents required. Any other suitable format known to those skilled in the art could also be used.

User Configuration Module (UCM)

The UCM 21 works on two levels. The first level provides a means to emulate each mobile device type in the system and configure the MDSC 22 of those devices 4 so each respective mobile device provides the required user interface (including graphical interface and functionality) to enable user in the field to carry out the required tasks. At another level, it also generates the underlying configuration data reflecting the system operator configurations, that enables the deployment of the configurations to the mobile devices 4, and integrates the mobile devices and ECS 2 to enable data transfer between them in accordance with the new configurations. To facilitate this, the preferred UCM 21 will emulate on screen both pictorially and functionally, a mirrored simulation of what the end application would look like and function like, on the target mobile device 4.

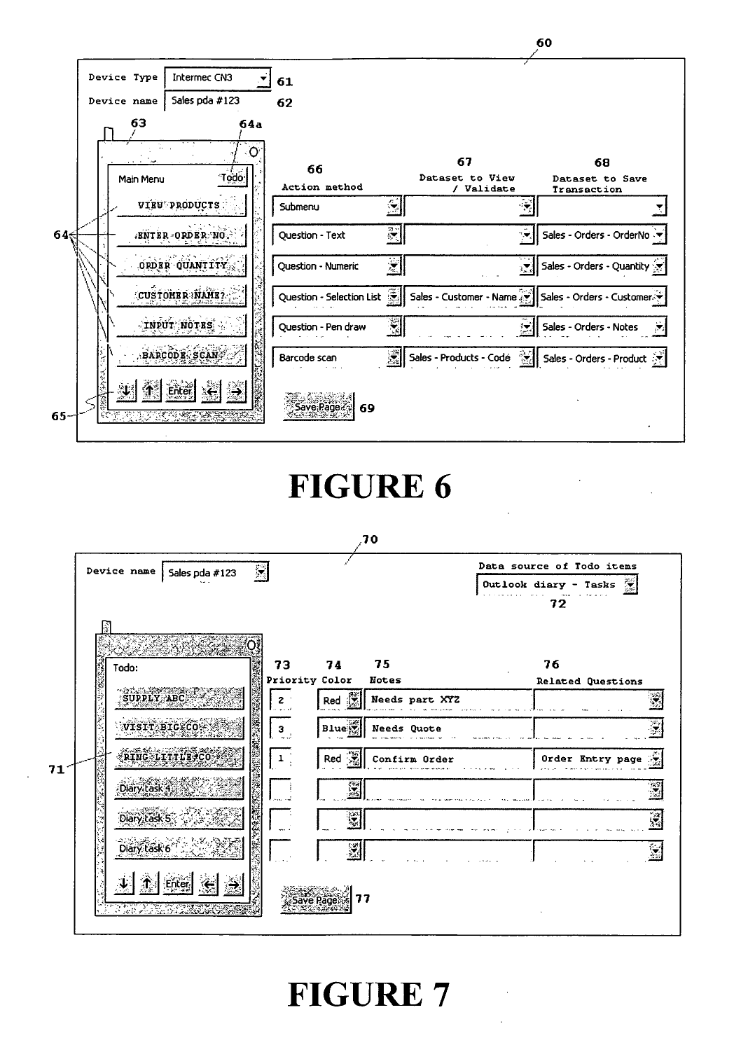

FIG. 6 shows in schematic form a generic user interface 60 of the UCM 21, including the screen design elements for developing the scheduling functionality and graphical user interface for execution on the mobile devices 4. By means of an emulation screen, the configuration software is made to appear with a similar graphical display to the intended run-time version of the mobile device 4 display for which configuration is taking place, displaying the same functional elements 64. The UCM 21 provides editing of the screen displays for the mobile device, to provide the required scheduling functionality, then allows simulation in run-mode to trial the resulting functionality/GUI that is configured. This may then be simulated over a network or across real mobile devices 4 with the MDSC 22 loaded, which will receive operating parameter files generated from that model, interpret and run that model immediately as configured by the system operator.

The structure of the mobile device 4 functionality and GUI is defined by ‘pages’. Each ‘page’ (e.g. 64) represents a screen-full display of display or menu elements 64 on the mobile device 4, as appropriate to the screen display capability of the device. These “pages” can be organised into a user-configurable hierarchical menu structure of options (with user-defined titles), so that the design may support many “pages” of business activity processing, each with its own navigational title meaningful to the user but entirely configurable by the UCM 21. More detail on the actual functionality is described later on. With reference to the user interface in FIG. 6, the functionality and GUI of mobile devices 4 is configured as follows. The mobile device 4 type is selected (in this example “Intermec CN3”) from a drop-down list of possible mobile device types from different vendors that are support by the UCM 21. This controls the display picture characteristics of the device illustration 63 to closely resemble the actual device. A device name or id is specified in field 62 to enable automated deployment of device configurations by the software as soon as the configuration for the selected mobile device is completed and saved by clicking the “save page” button 69. The configurations are deployed to a mobile device having a mobile client software installed and having the selected identifier pre-set in the mobile software. Given this capability, it is possible that various UCM 21 hosted by various companies may each deploy a customised application to the same client mobile device, who can select upon start up which host UCM session the user wishes to participate in at that time.

The simulated navigational buttons 65 acting in identical function to that of the mobile device 4, enables this emulation to navigate through identical screens to the target device. The difference to the actual mobile device on which the configuration will be deployed is that the page titles and options are directly editable on this screen so that the UCM system operator may customise and save the configured mobile device functionality. The mobile device emulation displays a number of editable menu elements 64, the label of which can be edited to identify their function. The function could be a link to a sub-menu, a link to data pertaining to a data field, a barcode scan, data input, information request, or any other functionality required. For example, one menu element is edited to say “Customer Name?”. Another is edited to say “Barcode Scan”. Next to each menu element 64 is a field with a drop-down list of action methods 66 that may be individually selected to configure the function of the associated menu element. Six example methods are illustrated in FIG. 6 next to the six menu elements 64, which provide the basic input and action options allowable, when the end user (on the target mobile device) selects the indicated corresponding menu element in the run-time version. Other methods will be known to those skilled in the art, and the six shown are merely exemplary. In the example shown, the method associated with “Customer Name?” is configured with a method to provide a question (such as “Please enter customer”). The method associated with the last menu element would be “Barcode Scan” As a further example of the software implementation logic, at run-time on the mobile device the software would pop-up a numeric keypad when the user selects the “ORDER QUANTITY” element as illustrated, this being applicable for the data type selected.

A corresponding list of six exemplary datasets 67 populated from the shadow data fields in the MDI 31 linked to the UCM 21 module enables configuration of source data to populate the action method that has been selected. For example, in respect of the question method for “Customer Name?”, a data field dataset is selected that is defined as being sourced from the data table “Sales—Customer—Name” from the MDI 31. In the illustrated example of the Barcode scan at (menu option 6) this would validate the barcode scanned from the table “Sales—Products—Code” rather than display a list, because the software has this logic built into it to process results on the basis of data type applied. Fields 68 enable the system operator to specify the storage location for input data from the mobile device user in response to the respective methods (such as questions). This input data is saved as new transactional data into the MDI 31—which is subsequently relayed to the ECS 2 by the MDI 31. In summary, in reference to FIG. 6, the menu options 64 are edited to specify the question to ask, or other required functionality. The associated configuration field 66 defines a method, such as how to ask the question. The respective dataset configuration fields 67 define optionally what to ask, and the configuration fields 68 define where to store the answer.

Once the system operator has configured the desired functionality and GUI of the mobile device 4 through use of the interface 60, including specifying shadow data fields, the UCM 21 generates configuration data representing the system operator configurations. The configuration data includes user interface definitions which are stored in the UI definition file 32. This specifies the menu options, the actions associated with those menu options, the shadow data fields associated with the actions, and the shadow data fields to which input data should be transferred. This configuration, data when transferred to the respective mobile devices, enables those devices to configure themselves to carry out the designed functionality and render the designed GUI. The configuration data in the UI definition field 32 is then deployed to the mobile device 4 identified during the next update procedure. The update procedure will be described in detail later on.

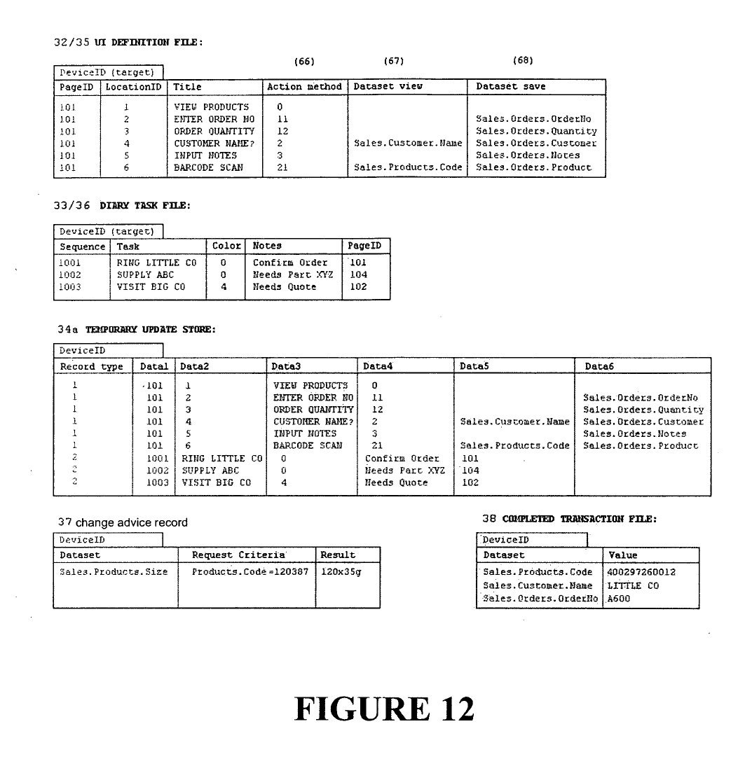

The emulated graphical interface 63 also includes a “TODO” button 64a. This leads to the menu with all the diary tasks that are nominated for a user of the mobile device to carry out. The diary tasks in this menu can be edited at run-time, and therefore preferably this portion of the mobile device 4 functionality and GUI are configured using the optional Run-time Scheduling Module (RSM) 23. When activated in the UCM 21, the “TODO” button activates the RSM 23, which will be described later in relation to FIG. 12. Alternatively, it is possible for this configuration to be carried out using the UCM 21.

Run-Time Scheduling Module (RSM)

Once the configuration of the mobile device 4 and system has taken place using the UCM 21, and the configuration has been deployed and implemented, a RSM 23 provides a user interface to centrally maintain and coordinate schedules of pending activities for each or several of the mobile device users. This includes:
1. An editable list of diary items
2. For each item,
   a. Ability to set priority of this task
   b. Set a colour code for this task (as displayed on the mobile device)
   c. Additional job information with definitions mapped to the DLAI for automated data population
   d. Supplemented with free text information
   e. Definition of a corresponding Activity page (as FIG. 6) to which the mobile device user will be directed upon selection of that diary item task
3. Definition of automated schedules import from the MDI with respect to automated population of diary items at regular intervals prescribed, for each mobile device.

FIG. 7 shows a user interface 70 of the RSM, that includes the mobile device's display of a “TODO list” which during run-time is reached by activating the “TODO” button displayed on the mobile device screen. During run-time the scheduling component enables alteration of the diary tasks and other parameters of the to-do list that appears on the mobile device. The diary tasks 71 may be edited directly or an automatic population of these items defined by selection of an available MDI data field source 72. In a similar fashion to the UCM 21, for each diary task the user may set values for each of:
Priority (sequence) number 73
Colour for highlight on the mobile screen 74
Input free-text Notes 75 for display as per FIG. 11
Select a Question page title 76 from a list of all question pages (i.e. FIG. 10) as defined in UCM 21 for this device.

For example, as shown in FIG. 7, there are three diary tasks each with a configured menu element 71. They are “Supply product to ABC”, “Visit Big Co.” and “Ring Little Co.” These tasks have been sourced from a “Diary Tasks” data field in the enterprise computer system, as shown in data source field 72. Each menu element has been labelled with the diary task as per the entry in the data source data field, and each has been assigned a priority and colour. In addition, notes can be provided and related questions can be defined. This enables a system operator to dynamically schedule tasks that can be deployed to respect mobile devices, and displayed in accordance with the functional and GUI configurations of the respective mobile devices 4. Once a schedule defined on the interface 70 is completed, the “Save Page” button is pressed and configuration data detailing the schedule stored in the diary tasks file 32. This information is then deployed to the mobile device 4 identified during the next update procedure. The update procedure will be described in detail later on.

The RSM could also enable the rearrangement of diary tasks between different mobile devices of different users. This could be by way of an additional screen, showing tasks on various devices, and facilitating rearrangement.

It should be noted that the RSM 23 is optional, and the invention could operate without this module.

Mobile Device and Mobile Device Software Client (MSDC)

Each mobile device 4 has a processor, communications system, memory and other data storage capability, display and input means, as is known to those skilled in the art. Each mobile device could be one of a range of different types of such devices provided by a range of vendors. In combination with the MDSC 22 which it executes, the mobile device is adapted to configure itself as a user interface to carry out the functionality designed on the UCM 21, and in particular display, store and receive data and menu elements. The data can be received from the server-side subsystem and can be received from a user of the device via an input means. The shadow data fields defined for use by the mobile devices 4 and datasets contained in those data fields are stored in the mobile device memory in a suitable manner known to those skilled in the art.

The MDSC 22 is a client application loaded onto each participating mobile device 4. It comprises all the components shown in the dotted box of FIG. 3 and as described in relation to that Figure. The preferred method of development is the Microsoft VB.Net mobile device programming language, and installation would be facilitated by a standard Microsoft Setup program. The MDSC 22 enables the mobile device on which it is installed to communicate with the server side of the subsystem 30 to receive configuration data from the UI definition 32 file and the task file 33. It further enables the device to configure itself using the configuration data such that it carries out functionality designed by the user on the UCM 21, renders a GUI in accordance with the design, and allows transfer of data to synchronise data entries in shadow data fields between the mobile device 4 and associated data fields in the ECS 2. Once installed, a text definition file related to the program is configured with a unique device name and a defined URL to the host TCP/IP network address, and the application is ready for use. This application has the ability to self-configure and re-configure its own user interface dynamically acting on message files from each server-side system to which it is addressed.

Periodically, the MDSC 22 communicates with the server-side subsystem 30 to exchange data in an update process to be described in detail later on. During exchange, the MDSC 22 receives configuration data from the UI definition file 32 and the diary task file 33 in the server-side subsystem 30. Preferably, the configuration data is in XML format, although any other suitable file format could be used. Within the structure of the XML message file is a checksum facility so that the receiving application (MDSC) is able to verify that the file has arrived undamaged. If so, it removes the file from the server after advising next version # as a flag to the UCM 21. Now the MDSC application parses and interprets the xml message file, to construct and maintain the following structured XML data files for use by the (i.e. its own) User Interface:
User Interface definition file
Diary items pending action
Data lists required for population of selection lists on question screens

This received configuration data is stored in the UI definition file 32 and diary task 33 definition file which form part of the MDSC 22. Now the MDSC application uses each of these XML definition files to dynamically build its own screen layouts to display to the user. Given that screen layouts conform to standard common formats, upon startup it will parse the UI definition file (stored locally 35) to construct the Main Menu options. As each navigation button is pressed on the screen the application parses the UI definition file 35, or diary tasks 36 file, or data list files as applicable to build and display the resulting screen. Thus the mobile device 4 can change functionality and its GUI 40 dynamically, reacting to events advised by the server-side subsystem 30 over a real-time but non-persistent communications medium. Once the initial MDSC 22 has been installed on the client device 4 it has the perpetual capability to upgrade itself and ‘learn’ new business rules dynamically based on configurations made in the UCM 21 and RSM 23.

During the update process, the MDSC 22 also performs a similar file transfer mechanism in the reverse direction, collating all new transactional data created using the MDSC User Interface 40, which would be operating concurrently, into a send message file stored in the completed transactions file 38. The data in the completed transactions file is then copied to the server-side subsystem 30. The UCM 21 similarly parses each message file received and merges its data instructions into the MDI, which subsequently triggers the MDI 31 generation module 20 to relay these new transactions to the ECS 2.

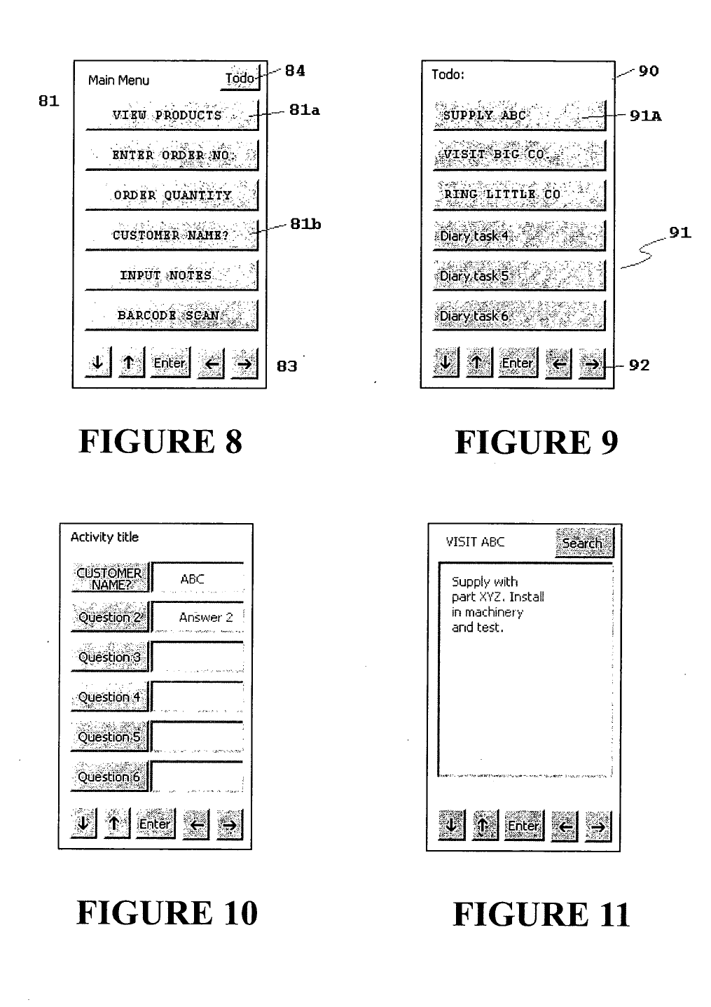

FIG. 8 shows the display of the mobile device 4 once it has configured itself in accordance with the configuration data generated by the system operator using the UCM 21. As can be seen, the display is configured to mimic all the menu elements 81 designed on the UCM 21 as described in relation to FIG. 6. A main menu of options is presented to the user for selection upon program startup. This menu might further branch to other menu pages of sub menus e.g. button 81a, with each menu list having a title and menu option items and navigational buttons 83 with which to navigate through the hierarchical menu structure, or scroll up and down through more available menu items for selection. Alternatively, the menu item might relate to a question, for example “Customer Name?” 81b, or the menu item in the case of “TODO” button 84 provides a link to a set of diary tasks.

Referring to FIG. 9, upon clicking the “TODO” button 84, the user is taken to a to do list screen 90, which lists the diary tasks 91, as configured using the RSM 23 in the manner described above. The diary items on this screen would be regularly populated by requests issued from the RSM 23. Each item would typically branch directly to an information display page revealing further particulars about the task, then further to an activity page upon which questions are asked related to this diary activity. For example, clicking on a menu item 91a in the to-do list might bring up the information screen, such as shown in FIG. 10. A title for the page related to the diary task or activity is displayed, below which is displayed information relating to the diary task. The menu element in FIG. 9 and the display in FIG. 11 relating to the diary task will be configured according to the selections made in the RSM interface screen 70 shown in FIG. 7. A search button enables the user to search current records of similar data to that highlighted by the user and display this data also in the information panel. In addition, questions might be asked, and information entered in response. The fields in this screen can be populated with information from associated data fields in the enterprise computer system and entered data can be transferred back to those data fields during the data synchronisation process.

Such as in the case of the “Customer Name?” menu element, clicking on an element may take the user to an activity page upon which questions are asked as shown in FIG. 10. The user may elect to view or input data on an ad hoc basis at any time, or may be taken to same screens as a result of a diary item request as described following. A list of questions defined by the system operator via the UCM user interface 60 are presented to the user for selection or input. In general, there may just be one question, or multiple questions. Upon selection of a question the software will display an input facility corresponding to the data type requested. This could be in the format of a pop-up numeric keypad or alpha keypad or free-form writing or drawing panel, or a list of available pre-defined selections or may prompt the user to collect the data via a peripheral device attached to the mobile computer eg. Barcode scan. The answers provided are displayed for visual confirmation before saving/sending (indirectly) to the ECS 2.

Referring back to the menu elements in FIGS. 8, 9 and 10, the MDSC 22 configures functionality of the mobile device such that the questions and shadow data fields configured in relation to each menu element are implemented on the mobile device. For example, the “Customer Name?” question which relates to menu option 4 is linked to a shadow data field defined in the device memory, which in turn is associated with one or more data fields in the ECS 2. When information is entered into the device in relation to this field, in the question screen in FIG. 10, update data is stored in the transactions completed file 38, and ultimately the temporary update store 34b in the mobile device. Upon the update procedure, the data in the shadow field is thus transferred to the associated field in the ECS 2. Similarly, data in the data field in the ECS is during update transferred to the shadow data field in the mobile device, for use and display by the device 4. The transfer of data between the shadow data field defined in device memory and the associated device in the ECS 2 is referred to as data synchronisation. Similarly, shadow data fields are defined for the remaining menu options where appropriate which enables data synchronisation with the associated data fields in the ECS 2.

In summary, the structure of the preferred mobile device application allows for the following basic functions, which are presented to the user in a consistent manner and interface regardless of the variable content of specific questions or information displayed:
A hierarchical set of menu options.
These menu options leading to activity pages
These activity pages to contain diary items to complete and/or;
Questions and answers in pre-defined formats to complete and/or;
Display of related information from the ECS

Having navigated through the menu structure, the user would arrive in each case, at an activity page with elements as illustrated in FIG. 8. Each page may collect business data from the user, or display relevant data from the ECS 2. The UCM 21 enables configuration of any data from the MDI to be displayed at various screen locations on any page. Conversely, the UC module can define any question prompts from the mobile device user, to collect data from the device (either by manual input or configuration to a peripheral electronic measurement or data capture device attachment to the mobile device) and update this answer with an automated date and time allocation for the transaction, back to the MDI (and subsequently, the ECS as new transactional data).

The mobile device could support fingerprint recognition to control access to the device and validate a user.

Communications between Server-Side Subsystem and Mobile Devices

Referring back to FIG. 3, the communications between the server-side subsystem 30 and the mobile devices 4 will be described in detail. The communications enables deployment of the mobile device configurations to enable configuration of the devices to provide the user interface, including the desired functionality and GUI. Further, the communications provides a data synchronisation or update process in accordance with the configurations.

As described earlier, the server-side subsystem 30 includes a UI definition file 32 which contains configuration data for configuring the mobile device with the required functionality and GUI, and a diary task file 33 which contains configuration data for providing scheduled tasks to the mobile device. The temporary update store 34a stores data reflecting changes in both files since the last update or synchronisation procedure with the respective mobile device 4. The MDSC 22 on the mobile device has UI definition file 35, diary task file 36 data request file 37 and completed transactions file 38. It also has a temporary file 34b that stores data reflecting changes in these files since the last update or synchronisation. This MDSC 22 software connects its temporary update store to that of the configuration interface via standard (radio) telecommunications protocols to relay data at regular intervals, as appropriate to the telecommunications service available.

The communications setup provides an inherent fault-tolerant service by allocating off-line temporary storage at both locations which synchronize each end's data contents by confirmation and validation of sequential message files before activating them, in both directions from the mobile device. This reduces the risk of data loss from the mobile business operation deployment. The telecommunications transfer process is triggered at the mobile device 4 by means of a polled data transfer process at regular intervals controlled by a preset timer which checks for new messages at either end of the connection in the temporary message folders 34a and 34b. The incoming messages are extracted into the various data groups required for use by the MDI 31. Application software 39 on the mobile device to construct the GUI 40 in real-time and collect transactional data to be relayed back through the same/reverse process back to the Server.

It should be noted that the UCM 2 itself provides such a replicated off-line storage of mapped data fields from the ECS 2 in the same fashion. The MDI generation module 20 defines which datasets from the ECS 2 are to be replicated as a synchronized database in the MDI 31. Any industry standard database synchronization protocol may be utilized for this function (eg. Oracle PL/SQL or SQL triggers). So the entire system is based on a fault-tolerant data redundancy communications backbone. In reference to the drawing FIG. 5 the MDI provides a database storage of replicated data from the ECS as defined by the MDI generation module 20. Acting from data within this MDI database, the UCM 21 extracts (for each individual participating mobile device assigned) a temporary User Interface definition file 32. Likewise the RSM 23 extracts a temporary file 33 of current diary requests for the individual participating mobile device 4 assigned. These files are maintained in a temporary message folder 34a awaiting telecommunications transfer to the mobile device 4.

Having collected user inputs as described the UCM 21, RSM 23 and MDSC 22 act together to store and move data files in the manner described, to complete the communications and deployment process. In the preferred software development implementation, the UCM 21 software having collected user defined configuration settings for each individual mobile device to be deployed, stores these settings in a structured XML file on the desktop pc/server where the UCM is run, in individual files discrete to each mobile device (name) specified. The UCM 21 does not attempt to parse or extract data from the MDI 31 in this step; it is simply recording a definition file of the chosen operating parameters of each mobile device 4. Typically these definition files would not be changed often after initial creation; from that point the UCM 21 acts primarily in an automated background processing role to collate and relay message data as described following. The RSM 23 stores data files in a similar fashion, to an XML file for each participating mobile device, but typically on a regular basis as these user inputs are related to regular transient transactional data.

The UCM operating in its automated background processing mode now collates (on a regular timer control) all required message data to be relayed to each mobile device, into discrete XML files for each device ready for collection by the MDSC 22 at a shared network location.

Each XML transmission file contains ‘change advice’ records for each of the following events:
Changes to the User Interface definition file
Changes to any records contained in tables in the MDI nominated for use by his device, as parsed from its UI definition file
New diary items generated by the RSM

On a timer the application polls the server at regular preset intervals across a public data transport protocol (i.e. any standard communications protocol provided with the device hardware, typically GPRS/CDMA telecommunications or 802.11 WIFI) to request the waiting message file nominated for this device (i.e. user) on that server (generated by the UCM as described above).

Data Structure of UI Definition, Diary Task, Temporary Update Store, New Data Request and Completed Transaction Files.

The files 32, 33, 34a, 34b 35, 36, 37 and 38 used for transferral of data relating to configuration and synchronisation utilise a suitable data structure to store the information. FIG. 12 shows one example of a data structure that could be used for each file 32, 33, 34a, 34b, 35, 36, 37 and 38, although this is exemplary only, and other data structures could also be used. It will also be appreciated that FIG. 12 shows only a portion of each file for clarity reasons. Each file could contain a large number of fields and entries as required, and a separate file might be used for each mobile device, and mobile device type, as required. Each file indicates a DeviceID to indicate this. The fields and the data entries populated therein are in accordance with the system operator's configurations selected, as described above.

Referring to FIG. 12, the UI definition files 32, 35 for the server-side subsystem 30 and mobile device side subsystem are shown. They include PageID and LocationID fields which contain entries showing the location on the page and the page itself in the menu structure, of each menu element that has been configured in the UCM 21. These particular tables relate to the configuration example shown in FIGS. 6 to 11. The Title field shows the system operator defined label for each respective menu element, and the Action Method field shows which action was configured. The Dataset View and Dataset Save fields relate to the shadow fields that will be deployed for use on a mobile device 4, and for which data synchronisation will take place between the mobile device 4 and the ECS 2.

The diary task files 33, 36 for the server-side subsystem 30 and mobile device side subsystem are also shown. The data entries and fields are in accordance with the configurations that are preferably made in the RSM 23 as described above. They include a Sequence field for indicating an order of the tasks, along with a Task field identifying the task, a Colour field for display purposes, and Notes field, and a PageID showing which page the task will be displayed on in the mobile device 4 GUI.

The Temporary Update Store files 34a, 34b reflect changes in the other files since the last synchronisation, and therefore indicate what data needs transferral between the mobile device 4 and the server 30 at next synchronisation. A Record Type field indicates the data type of record that needs updating, e.g. task or data associated with a menu element. Data1, Data2 and Data3 fields indicate references and labels respectively that identify the data requiring synchronisation. Data4 specifies the actual data that requires transferral during synchronisations and Data5 and Data6 fields show the source and destination data fields that the Data4 will be transferred between.

On occasion the mobile device may relay a user-generated request to the MDI 31 for specific supplementary information activated on-demand by the Search button on the Information screen (see FIG. 11). The change advice record 37 provides a structure for accumulating this request and the subsequent answer provided by the MDI 31. This file data is relaying to and from the MDI 31 via the Temporary Update Store files 34a, 34b in the same manner as 32,33,35,36.

All user responses to the Questions Screen (see FIG. 10) are collected in the Transactions Completed file 38 for relaying to the MDI 31 via the Temporary Update Store files 34b, 34a. The Transactions Completed file 38 includes a Dataset field providing the target location in the MDI 31 and a Value field providing the results data collected from the user, to be stored in the MDI 31 as transactional records.

As can be seen, synchronisation takes place by transferring data relating to the changes in the fields since the last synchronisation. This reduces the amount of data that requires transfer during synchronization. That is, the system does not transfer all data between the shadow data fields and associated data fields in the database, rather it only transfers data reflecting changes since the last synchronisation.

Method of Use

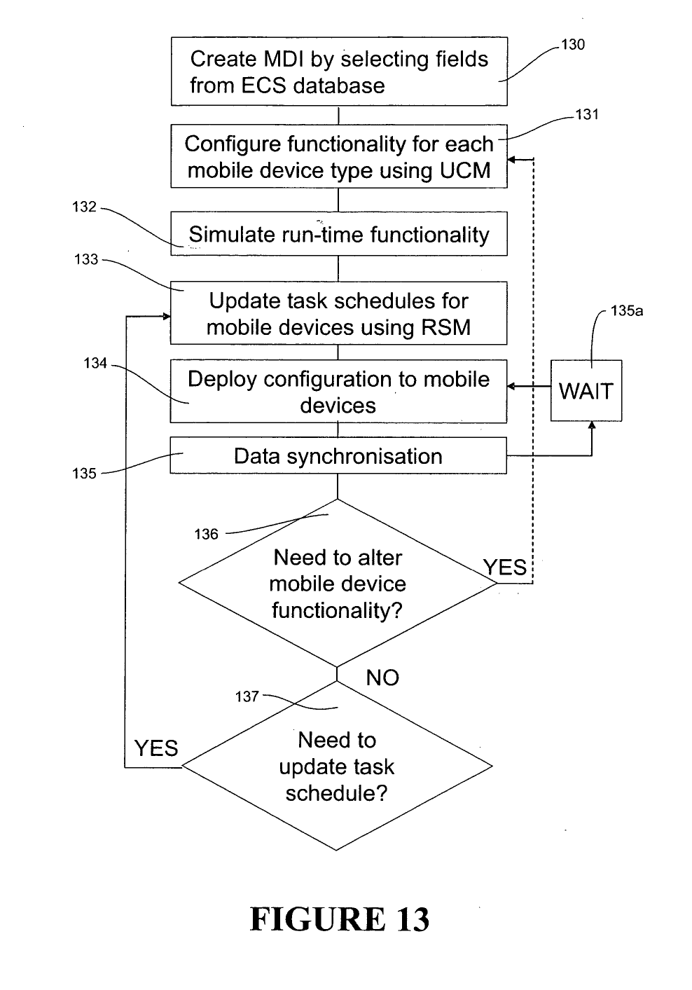

The flow charts in FIGS. 13 briefly summarise the method carried out by both an operator and the system during operation of the invention, as described in more detail above.

Firstly, in step 130, the MDI 31 is created by the system operator using the MDI generation module 20. The system generates the MDI 31 in accordance with field selections made by the system operator, and periodically updates the data entries therein by synchronising with the ECS 2. Next, step 131, the system operator configures the desired functionality of each mobile device 4 using the UCM 21. In addition, step 132, the system operator may simulate their configurations for each mobile device 4 using the UCM 21. Next, step 133, task schedules can be configured using the RSM 23 (often this may take place after initial deployment of configurations). It will be appreciated that this sets out the initial set up, but reconfiguration can take place at will by the operator, as indicated at step 136, 137 as reconfigurations are required. Next, step 134, the configurations are deployed, during a synchronisation update procedure carried out by the system on a timer basis as described earlier. Also, step 135, data synchronisation takes place as described. It should be noted that steps 134 and 135 could occur in the same process. These two steps will occur repeatedly as shown at step 135a, as the system carries out the update process after waiting for a time.

It will be appreciated that the configuration and synchronisation steps of the method could occur in any order, and the order shown is merely for exemplary purposes. Update occurs periodically and reconfiguration can take place at any time as required by the operator.

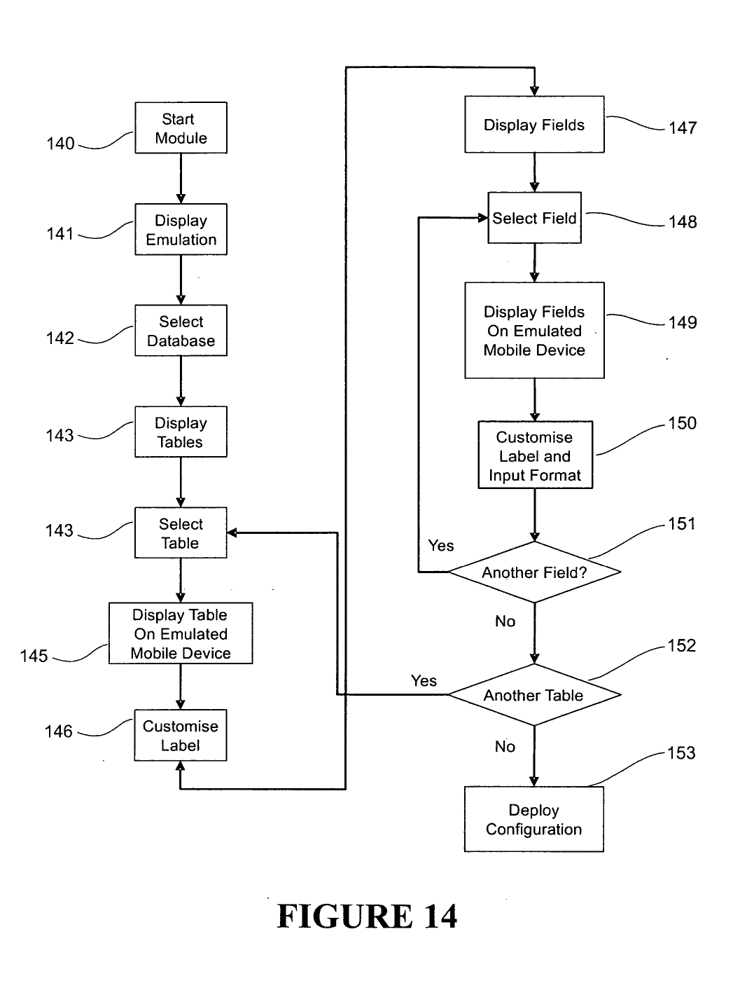

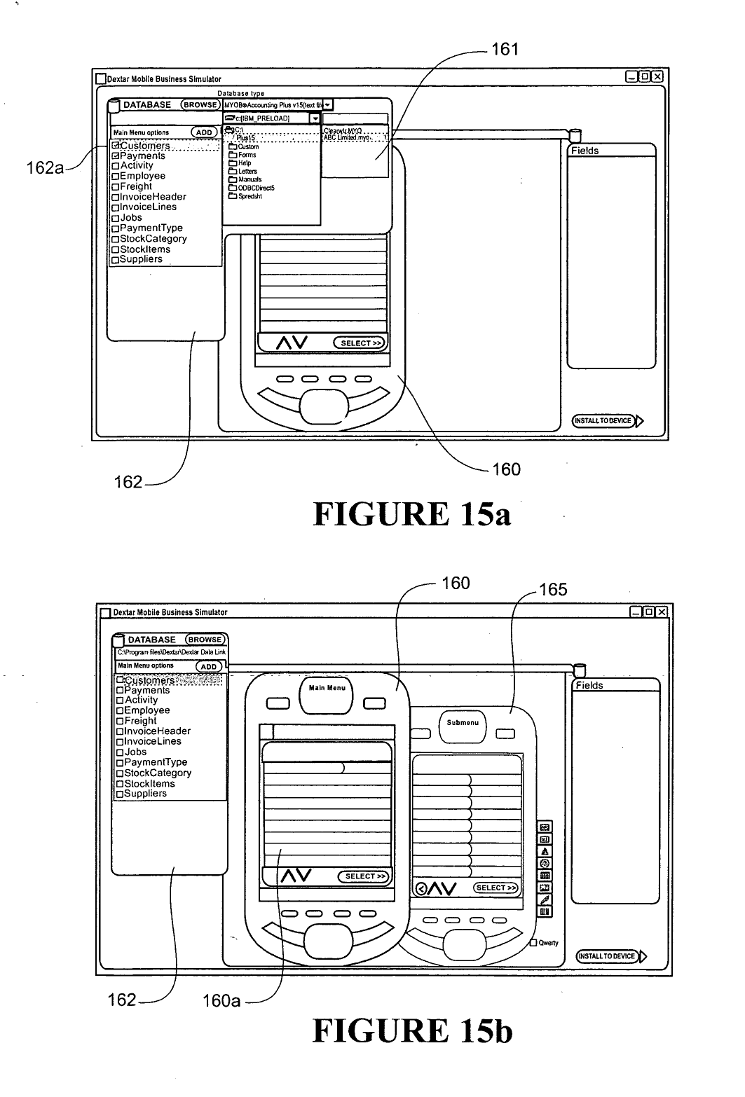

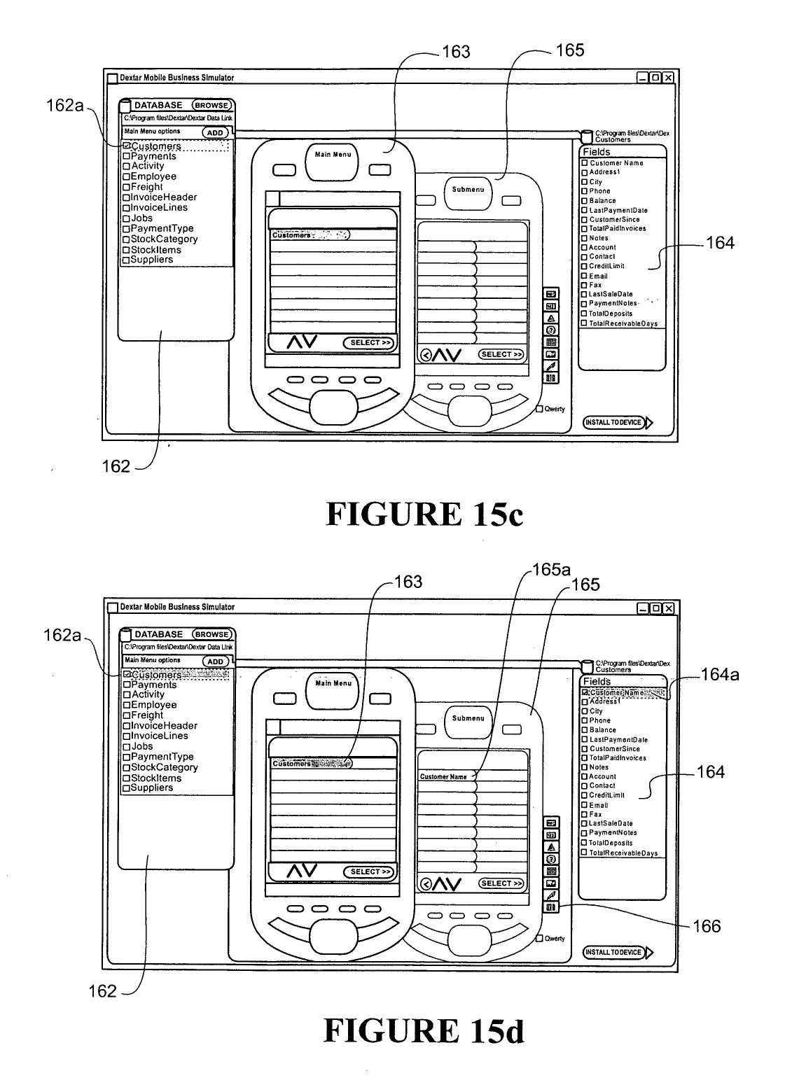

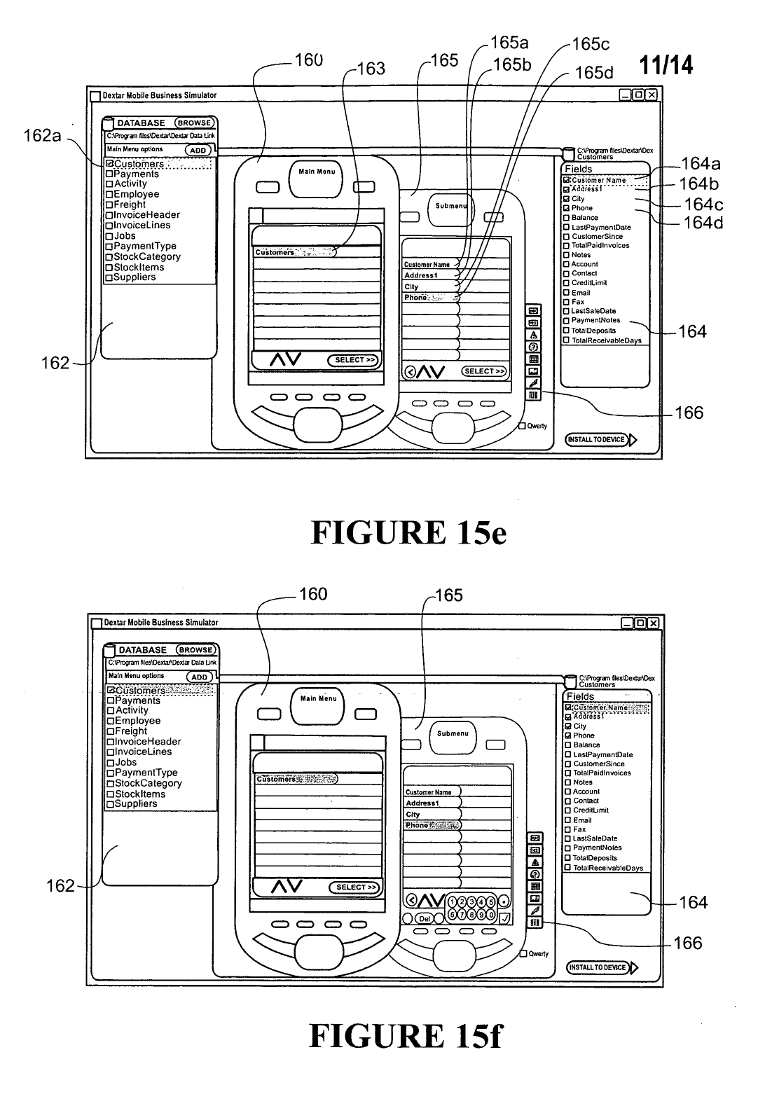

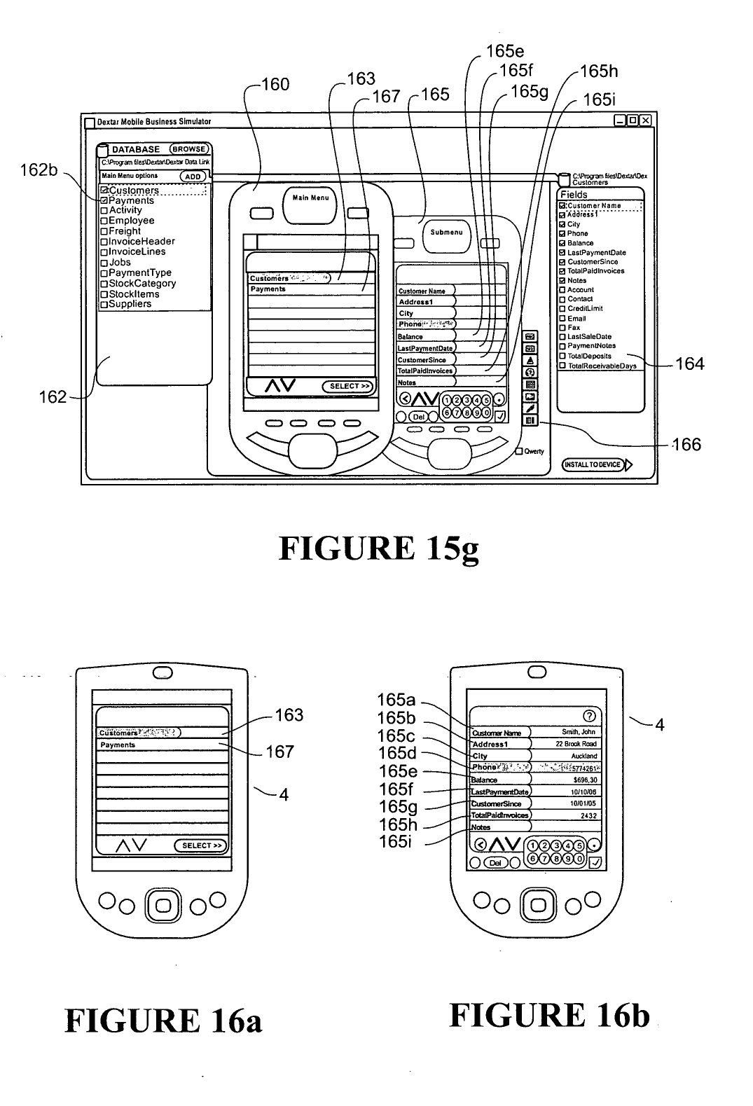

A particular example of a configuration of a mobile device in accordance with the invention will be described with reference to FIGS. 14 and 15a-15g. This example is relates to another embodiment of the invention. While the particular look of the UCM 21 user interface and the actual process undertaken looks slightly different to that described in relation to the generic example of FIGS. 4 to 11, it will be appreciated that this example is conceptually similar to the previous example. This example also shows in further detail the actual steps taken in configuring the user interface as various menu elements and associated shadow fields.

First the user (system operator) starts the UCM 21, Step 140. The UCM displays an emulation of the mobile device 160 as shown in FIG. 15a, Step 141. It also displays a list of possible databases that the ECS 2 contains. In this case two databases are available as shown in window 161. The user then selects the database they wish to create an interface for, Step 142, which in this case is the “ABC Limited myo” database. The emulation shown in FIG. 15a then displays a list of tables defined in the selected database. The tables are shown in the window 162. Initially as shown in FIG. 15b the emulation shows a blank screen 160a on the mobile device 160. One or more of the tables 162 can be selected and a menu interface configured for accessing the tables from the mobile device 4. For example, referring to FIG. 15c, in this case the customer table 162a is selected, Step 144 and a “customers” menu element 163 corresponding to this table is displayed on the emulation of the mobile device 160, Step 145. The UCM 21 then generates configuration data relating to this element and the table for deployment to the actual mobile device to replicate this menu item and associated fields. If desired, the label “customers” on the menu element 163 can be customised to an alternative label if required, Step 146.

Upon selecting a table, a range of data fields relating to that table are displayed in a window 164 as shown in FIG. 15c, Step 147. These fields are the data fields associated with the table in the database stored by the enterprise computer system 2. These data fields 164 are the fields that the user can select, Step 148, for configuring the mobile device interface. Each selected field becomes a shadow field defined in the MDI 31. Each shadow data field is defined by the generated configuration data such that when deployed to the mobile device it provides an interface on the mobile device to the actual data field in the enterprise computer system 2. Referring to FIG. 15d, in this case the user selects “customer name” 164a as one of the shadow data fields to be associated with the menu element “customer” 163. This can be done by checking the appropriate box in the list of shadow data fields 164 as shown. Once selected, the “customer name” shadow data field 165a is displayed on a submenu screen 165, Step 149. This label can be customised if required, Step 150. The user input format for the field can also be specified as shown by the icons 166. For example, the field can be specified as a data only field, a text only field, a locked field or restricted to a certain number of characters or any other suitable format as required.

As shown in Step 151 and FIGS. 15e, 15f further shadow data fields can be selected for configuration on the device 4. In this case the additional fields address 1 164b, city 164c and phone 164d are selected, and also their data input format specified as shown in FIG. 15f. Further, as shown in FIG. 15g and Step 152 additional tables can be selected 162b, and additional shadow fields 165e-165i associated with those tables. The resulting configuration comprises a range of menu elements 163, 167 relating directly or indirectly to shadow data fields 165a-165i. The shadow data fields relate to the selected data fields from the list of data fields. When these configurations are deployed to the mobile device, the mobile device can configure itself to provide a user interface to those specified shadow fields. When the user has completed their desired configurations, the appropriate configuration data for the menu elements and the shadow fields associated with those menu elements is generated and stored as required. This is then deployed, Step 153, to the mobile device in the manner described earlier.

FIG. 16a, 16b show the actual mobile device 4 once it has received the configuration data and has configured itself as a user interface. As shown in FIG. 16a, the graphical user interface of the mobile device shows the menu elements “customers” and “payments”. When a user selects one of these menu elements on the mobile device the actual shadow fields associated with that menu element are displayed. For example, as shown in FIG. 16b the shadow fields and their related data entries are displayed, associated with the customers table. The data entries pertaining to the shadow data fields shown in FIG. 16b are the same as those in the associated data fields in the enterprise computer system 2. The data entries are received by the mobile device via the system during the synchronisation process. The user can edit the data entries shown in FIG. 16b as required, in accordance with the job they carry out. Upon their next synchronisation process the data entries entered into the mobile device in relation to the shadow fields are synchronised with the data fields in the actual database. This means that after synchronisation the data fields in the database that have corresponding or associated shadow data fields configured on the mobile device contain the same data entries.

In effect, the mobile device provides a user interface to the database data fields which have corresponding shadow data fields configured on the device. It will be appreciated that the term “user interface” relates to more than just a graphical user interface. The user interface comprises graphical user interface as described, and also all the other required configurations to enable data synchronisation to take place between the specified shadow data fields in the configuration, and the associated data fields in the enterprise database.

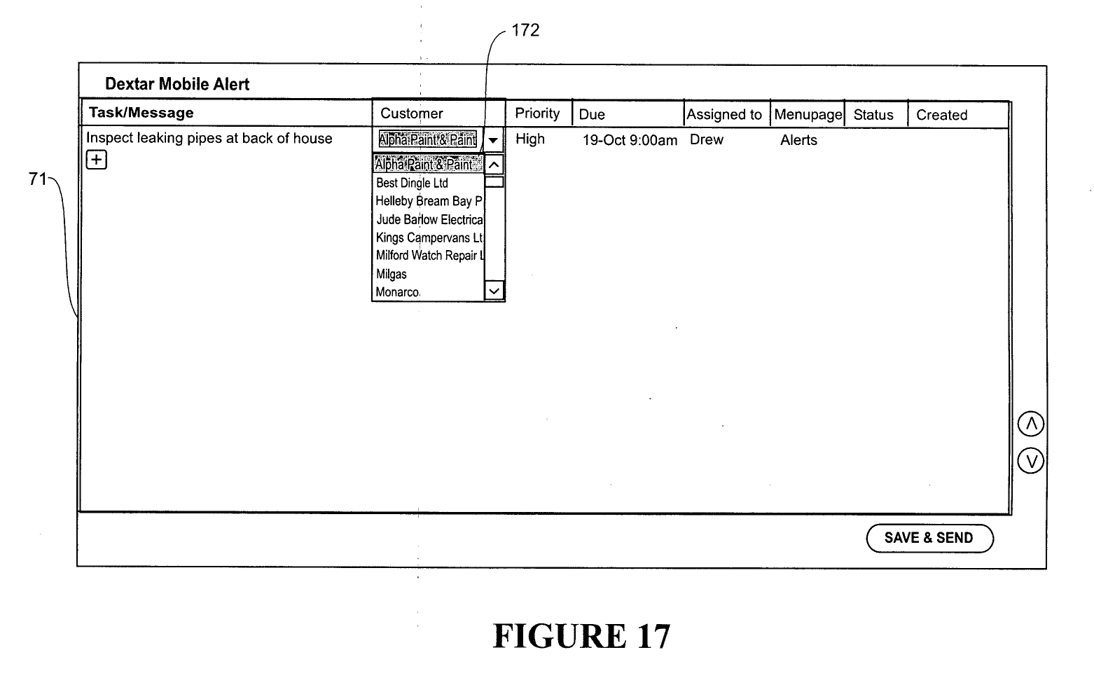

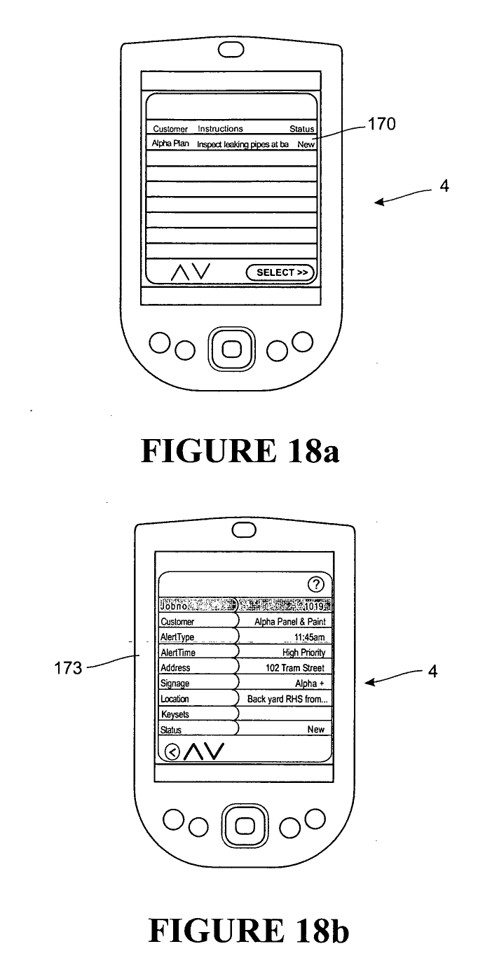

Referring to FIGS. 17 and 18a, 18b as described previously the UCM 21 can also be utilised to update tasks on a mobile device. The user can use the UCM 21 to provide actual tasks that can be deployed to one or more mobile devices, as part of the configuration data deployment. For example, as shown in FIG. 17 a particular customer “Alpha Paint and Paint” 172 requires someone to check or inspect the leaking pipes at the back of the house. This job request can be entered into an alert system 171 in the RSM module. Once entered, data is generated which is stored in the diary task file 33. This is then deployed to one or more of the mobile devices 4 on their next synchronisation process. Referring to the FIGS. 18a, 18b, the mobile device then receives this information along with other configuration data. It configures itself in relation to the data, and also updates information in the fields and on screen to display the diary tasks 170 that have been entered. Referring to FIG. 18a, the job request is displayed as shown 170. A user of the mobile device can then inspect information pertaining to that customer via the shadow fields 173 that have been configured on the device 4, as shown in FIG. 18b. This provides information on the job request and the customer. The user can also amend any of the information as required, perhaps in response to the job request being fulfilled. The diary tasks or alerts can be updated during the synchronisation process as new information becomes available.

Applications of the Technology

As described earlier, the system, method and software of the invention can be used to deploy functionality to mobile devices for use by employees or contractors that require access to an enterprise's database in order to carry out duties. In another application, the system, method and software could be used by retailers, wholesalers and the like to provide purchasing interfaces to their products and services for their customers. For example, a customer could enter a store with their mobile device. The store could have a local wireless network set up, for example using WiFi, that broadcasts its existence. The mobile device could detect this and then download configuration data that has been made available by the store retailer. The configuration data could be used by the customer's mobile device to configure itself to provide a user interface providing a menu of the various goods/services provided by the retailer. It could also synchronise with the store's inventory database so that the information is up to date in respect of goods/services available, the quantity remaining, the price and any other useful information. The customer could then place an order using their device and receive the required goods/services. The architecture of the present invention with the dynamic updating and synchronisation makes this application a possibility.

What we claim is:

1. A method of configuring one or more mobile devices to provide one or more user interfaces to at least one database on a remote computer system, the method comprising the steps of:
defining an index of one or more shadow data fields, each shadow data field being associated with one or more data fields in the at least one database, and
receiving input defining a user interface to the at least one database for deployment on a mobile device, and
generating configuration data specifying the user interface, the configuration data comprising data specifying one or more of the shadow data fields associated with the user interface,
wherein the configuration data is adapted to configure a mobile device as a user interface to the at least one database by:
configuring the mobile device to display, store and/or receive data entries in relation to the shadow data fields specified by the configuration data, and
configuring the mobile device for data synchronisation of data entries in relation to the specified shadow data fields with data entries in the one or more associated data fields in the database.

2. A method according to claim 1 wherein the configuration data is adapted to be received and utilised by a mobile device to configure itself to provide the user interface.

3. A method according to claim 2 further comprising the step of transferring the configuration data to one or more mobile devices during a communication session.

4. A method according to claim 3 wherein the configuration data is transferred over a non-persistent communications channel.

5. A method according to claim 4 wherein the configuration data is transferred periodically during a communication session

6. A method according to claim 1 wherein the step of receiving input defining a user interface to the at least one database comprises receiving input specifying one or more display elements for display on the mobile device, and wherein the generated configuration data further comprises data specifying the display elements.

7. A method according to claim 6 wherein each display element relates to one or more shadow data fields.

8. A method according to claim 7 wherein the step of receiving input defining a user interface to the at least one database comprises receiving input specifying, for at least one display element, one or more of the shadow data fields related to that display element.

9. A method according to claim 6 wherein the display elements comprise one or more of: menu options, icons, requests for information, data input fields.

10. A method according to claim 6 wherein the configuration data is adapted to be received and utilised by a mobile device to configure itself to provide the user interface, the user interface comprising a graphical display of the menu elements.

11. A method according to claim 6 wherein the configuration data is adapted to be received and utilised by a mobile device to configure itself to provide the user interface that receives data in relation to one or more of the display elements and stores the received data in one or more of the shadow data fields specified for a respective display element for which data is received.

12. A method according to claim 1 wherein the step of receiving input defining a user interface to the at least one database comprises receiving input defining tasks and/or questions for display and/or storage on a mobile device, wherein the tasks and/or questions are associated with one or more of the shadow data fields.

13. A method according to claim 12 wherein the configuration data further comprises data specifying one or more of the tasks and/or questions for display and/or storage on the mobile device.

14. A method according to claim 13 wherein the tasks and/or questions are associated with display elements and/or shadow data fields related to display elements.

15. A method according to claim 14 wherein the configuration data is adapted to be received and utilised by a mobile device to configure itself to provide the user interface, the user interface comprising a graphical display of the tasks and/or questions.

16. A method according to claim 3 wherein prior to the step of transferring the configuration data to one or more mobile devices during a communication session, the method comprises the step of storing the configuration data in an intermediary store.

17. A method according to claim 16 wherein the step of transferring the configuration data to one or more mobile devices during a communication session comprises transferring the configuration data from the intermediary store to a data store in each respective mobile device.

18. A method according to claim 16 further comprising the step of receiving data from one or mobile devices and storing the data in the intermediary store.

19. A method according to claim 18 further comprising the step of updating the at least one database with data in the intermediary store received from one or more mobile devices.

20. A method according to claim 1 further comprising the step of synchronising data in the data fields of the at least one database with data stored in relation to the shadow data fields specified by the configuration data.

21. A method according to claim 1 further comprising the step of transferring data from one or more data fields of the at least one database to one or more mobile devices for synchronising the specified shadow data fields associated with the user interface with associated data fields of the at least one database.

22. A method according to claim 1 comprising transferring the configuration data to a plurality of mobile devices.

23. A method according to claim 1 wherein the step of receiving input defining a user interface to the at least one database for deployment on a mobile device comprises:
receiving user input specifying the mobile device type of a desired vendor,
emulating a graphical user interface of the mobile device, and
receiving input selecting display elements with one or more associated shadow data fields.

24. A method according to claim 23 wherein the step of receiving input defining a user interface to the at least one database for deployment on a mobile device further comprises:
receiving user input specifying the at least one database, and
receiving user input specifying one or more shadow data fields.

25. A method according to claim 1 further comprising the steps of receiving the configuration data at a mobile device and configuring the mobile device as a user interface to the at least one database using the configuration data.

26. A method according to claim 25 further comprising the step of receiving further configuration data at the mobile device and re-configuring the mobile device as a re-configured user interface to the at least one database using the configuration data.

27. A method according to claim 26 further comprising the step of synchronising data in the specified shadow data fields with data in the data fields of the at least one database.

28. A system adapted to facilitate configuration of one or more mobile devices to provide one or more user interfaces to at least one database on a remote computer system, the system comprising:
a computer system comprising, or adapted to communicate with, at least one database that comprises a data structure with one or more data fields, each data field for storing one or more data entries, the computer system comprising at least one computer programmed to:
define an index of one or more shadow data fields, each shadow data field being associated with one or more data fields in the at least one database, and
receive input defining a user interface to the at least one database for deployment or a mobile device, and
generate configuration data specifying the user interface, the configuration data comprising data specifying one or more of the shadow data fields associated with the user interface,
wherein the configuration data is adapted to configure a mobile device as a user interface to the at least one database by:
configuring the mobile device to display, store and/or receive data entries in relation to the shadow data fields specified by the configuration data, and
configuring the mobile device for data synchronisation of data entries in the specified shadow data fields with data entries in the one or more associated data fields in the database.

29. A system according to claim 23 wherein the configuration data is adapted to be received and utilised by a mobile device to configure itself to provide a user interface.

30. A system according to claim 29 further comprising a definition file coupled to or integrated with the computer for storing the configuration data.

31. A system according to claim 1 wherein the system comprises a first transmitter and the computer is further programmed to transfer the configuration data to one or more mobile devices during a communication session via the first transmitter.

32. A system according to claim 31 wherein the configuration data is transferred over a non-persistent communications channel

33. A system according to claim 32 wherein the configuration data is transferred periodically during a communication session.

34. A system according to claim 28 wherein to receive input defining a user interface to the at least one database the computer is programmed to receive input specifying one or more display elements for display on the mobile device, and wherein to generate configuration data specifying the user interface the computer is programmed to generate data specifying the display elements.

35. A system according to claim 34 wherein each display element relates to one or more shadow data fields.

36. A system according to claim 34 wherein to receive input defining a user interface to the at least one database the computer is programmed to receive input specifying, for at least one display element, one or more of the shadow data fields related to that display element, and wherein to generate configuration data specifying the user interface the computer is programmed to generate data specifying, for the at least display element, the one or more shadow data fields related to the at least one display element.

37. A system according to claim 34 wherein the display elements comprise one or more of: menu options, icons, requests for information, data input fields.

38. A method according to claim 34 wherein the configuration data is adapted to be received and utilised by a mobile device to configure itself to provide the user interface, the user interface comprising a graphical display of the menu elements.

39. A system according to claim 36 wherein the configuration data is adapted to be received and utilised by a mobile device to configure itself to provide the user interface that receives data in relation to one or more of the display elements and stores received data in one or more of the shadow fields specified for a respective display element for which data is received.

40. A system according to claim 28 wherein to receive input defining a user interface to the at least one database the computer is programmed to receive input defining tasks and/or questions for display and/or storage on a mobile device, wherein the tasks and/or questions are associated with one or more of the shadow data fields.

41. A system according to claim 40 wherein the configuration data further comprises data specifying one or more of the tasks and/or questions for display and/or storage on the mobile device.

42. A system according to claim 41 wherein the tasks and/or questions are associated with display elements and/or shadow data fields related to display elements.

43. A system according to claim 42 wherein the configuration data is adapted to be received and utilised by a mobile device to configure itself to provide the user interface, the user interface comprising a graphical display of the tasks and/or questions.

44. A system according to claim 28 further comprising an intermediary store coupled to or integrated with the computer wherein prior to transferring the configuration data to one or more mobile devices during a communication session, the computer is programmed to store the configuration data in the intermediary store.

45. A system according to claim 44 wherein transferring the configuration data to one or more mobile devices during a communication session comprises transferring the configuration data from the intermediary store to a data store in each respective mobile device using the first transmitter.

46. A system according to claim 31 wherein the system comprises a first receiver, wherein the system is adapted to receive data from one or mobile devices via the first receiver and store it in the intermediary store, the data comprising data in the specified shadow data fields.

47. A system according to claim 46 wherein the system is adapted to update the data fields of the at least one database that are associated with the specified shadow data fields, the data fields being updated with data from the intermediary store received from one or more mobile devices.

48. A system according to claim 31 wherein the computer is further programmed to transfer data from one or more data fields of the at least one database to one or more mobile devices via the first transmitter for synchronising the specified shadow data fields associated with the user interface with associated data fields of the at least one database.

49. A system according to claim 28 wherein to receive input defining a user interface to the at least one database for deployment to a mobile device, the computer is programmed to:
receive user input specifying the mobile device type of a desired vendor,
emulate a graphical user interface of the mobile device, and
receive input selecting display elements with one or more associated shadow data fields.

50. A system according to claim 49 wherein to receive input defining a user interface to the at least one database for deployment to a mobile device, the computer is further programmed to:
receive user input specifying the at least one database, and
receive user input specifying one or more shadow data fields.

51. A system according to claim 28 further comprising at least one mobile device, the device comprising a second receiver adapted to receive configuration data transmitted via the first transmitter, wherein the mobile device is adapted to configure itself as a user interface to the at least one database using the received configuration data.

52. A system according to claim 28 wherein the mobile device is adapted to receive further configuration data transmitted via the first transmitter and re-configure itself as a re-configured user interface to the at least one database using the additional configuration data.

53. A system according to claim 52 wherein the mobile device further comprises a second transmitter, wherein the device is adapted to transmit data to the intermediary store via the first receiver, the data being for updating the data fields of the at least one database that are associated with the specified shadow data fields.

54. A system according to claim 53 wherein the mobile device is adapted to periodically communicate with the intermediary store to receive configuration data, and periodically re-configure itself as a user interface to the at least one database using the configuration data.

55. A mobile device comprising a transceiver and configuration software, the mobile device adapted to receive the configuration data of claim 22, and adapted to configure itself with the configuration software using the configuration data to provide a user interface to the at least one database.

56. A method for facilitating configuration of a mobile device and integration of the mobile device with a remote computer system comprising at least one database, to provide for data synchronisation between the mobile device and the remote computer system, the method comprising:
configuring a mobile device functionality and/or user interface, comprising selecting menu elements for display, methods for the elements and one or more shadow data fields related to the elements and associated with data fields in the database,
using software that configures a system to facilitate data synchronisation between the mobile device and database.

57. A computer program for operating a computer connected to at least one database to facilitate configuration of a mobile device to provide a user interface to the at least one database on a remote computer system, the computer program comprising:
a index module adapted to enable the definition of an index of one or more shadow data fields for use in configuring the mobile device, each shadow data field being associated with one or more data fields in the at least one database, each data field in the at least one database containing one or more data entries, and
a user configuration module adapted to enable configuration of the functionality of the mobile device, the user configuration module enabling a user to select one or more of the shadow data fields, wherein the user configuration module generates configuration data for configuration of a mobile device to display, store and/or receive data entries in relation to the selected shadow fields and for data synchronisation of:
data entries in the selected shadow fields displayed, stored or received on the mobile device, and
data entries in the one or more associated data fields in the database.

58. A computer program according to claim 57 wherein the configuration data is adapted to be received by the mobile device during a communication session, and adapted to be utilised by the mobile device to configure itself as defined by the configuration data.

59. A computer program according to claim 57 wherein the configuration data further defines tasks and/or questions for display and/or storage on the mobile device, and wherein the configuration data is adapted to be received and utilised by a mobile device to configure itself to receive, display and/or store tasks and/or questions defined by the configuration data receive data entries in respect of those tasks and/or questions.

60. A computer program according to claim 59 wherein the tasks and/or questions are associated with one or more of the shadow data fields.

61. A computer program according to claim 57 wherein the configuration data is adapted to be stored in a definition file that is in communication with a data store in the mobile device.

62. A computer program according to claim 57 wherein the user configuration module is further adapted to receive user input specifying display elements for association with one or more of the selected shadow data fields, the user configuration module adapted to generate configuration data defining the display elements and the respective associations of those display elements with one or more of the selected shadow data fields, the configuration data being adapted to be received and utilised by a mobile device to configure itself to display the specified display elements.

63. A computer program according to claim 62 wherein the display comprise one or more of menu options, icons, requests for information, data input fields.

64. A computer program according to claim 62 wherein the configuration data is adapted to be received and utilised by a mobile device to configure itself to receive data in relation to one or more of the display elements and store received data in one or more shadow fields associated with a respective display element for which data is received.

65. A computer program according to claim 62 that facilitates configuration of a plurality of mobile devices.

66. A computer program according to claim 65 wherein the computer program facilitates configuration of a plurality of different mobile device types supplied by different vendors.

67. A computer program according to claim 66 wherein the user configuration module is adapted to:
receive user input specifying the mobile device type of the desired vendor,
emulate a graphical user interface of the mobile device, and
display user specified display elements and/or the data entries for the selected shadow fields associated with those specified display elements.

68. A computer program according to claim 57 wherein the user configuration module simulates data synchronisation between data entries display, stored and/or received in respect of the selected shadow fields and data entries in the associated data fields in the database.

69. A computer program according to claim 57 wherein the configuration data is adapted to be stored in an intermediary store prior to data transfer to a mobile device.

70. A computer program according to claim 57 further comprising a run-time scheduling module for editing display elements, requests, tasks and information, the run-time scheduling module adapted to receive user input specifying changes to display elements, requests, task and information and generates update configuration data defining the changes, the update configuration data being adapted to received and utilised by a mobile device to configure itself as defined by the configuration data.

71. A method of configuring one or more mobile devices to provide one or more user interfaces to at least one database on a remote computer system, the method comprising the steps of:
defining and storing an index of one or more shadow data fields, each shadow data field being associated with one or more data fields in the at least one database, and
receiving user input defining a user interface to the at least one database for deployment on a mobile device, the user input comprising input specifying menu elements that are related to one or more shadow data fields, and input specifying one or more of the shadow fields to be associated with the specified menu elements, and
generating configuration data specifying the user interface, the configuration data comprising data specifying the specified menu elements and the one or more specified shadow data fields associated with the specified menu elements,
transferring the configuration data to at least one mobile device for use in configuration of the device to provide one or more user interfaces to the at least one database,
and configuring the mobile device using the configuration data,
wherein the configuration data is adapted to configure a mobile device as a user interface to the at least one database by:
configuring the mobile device to display, store and/or receive data entries in relation to the shadow data fields specified by the configuration data, and
configuring the mobile device for data synchronisation of data entries in relation to the specified shadow data fields with data entries in the one or more associated data fields in the database.

72. A system adapted to facilitate configuration of one or more mobile devices to provide one or more user interfaces to at least one database on a remote computer system, the system comprising:
an enterprise computer system,
at least one database communicating with or forming part of the enterprise computer system, the at least one database comprising a data structure with one or more data fields, each data field for storing one or more data entries,
a configuration computer system adapted to communicate with the at least one database,
at least one system transceiver form communicating with at least one mobile device, and
at least one mobile device with a transceiver for communicating with the configuration computer system via the system transceiver,
wherein the computer system comprising at least one computer programmed to:
define an index of one or more shadow data fields, each shadow data field being associated with one or more data fields in the at least one database, and
receive input defining a user interface to the at least one database for deployment to a mobile device, and
generate configuration data specifying the user interface, the configuration data comprising data specifying one or more of the shadow data fields associated with the user interface,
wherein the system is adapted to transmit the configuration data to the mobile device via the transceiver, and
wherein the configuration data is adapted to configure a mobile device as a user interface to the at least one database by:
configuring the mobile device to display, store and/or receive data entries in relation to the shadow data fields specified by the configuration data, and
configuring the mobile device for data synchronisation of data entries in the specified shadow data fields with data entries in the one or more associated data fields in the database.
